(19) United States
(12) Patent Application Publication
(10) Pub. No.: US 2021/0001215 A1
(43) Pub. Date: Jan. 7, 2021

(54) COMPUTER SYSTEM, AUTOMATIC PURCHASE SYSTEM, AND AUTOMATIC PURCHASE METHOD

(71) Applicant: BANDAI NAMCO ENTERTAINMENT INC., Tokyo (JP)

(72) Inventors: Naoto NAGASHIMA, Tokyo (JP); Tamaki UCHIBORI, Tokyo (JP)

(73) Assignee: BANDAI NAMCO ENTERTAINMENT INC., Tokyo (JP)

(21) Appl. No.: 16/921,005

(22) Filed: Jul. 6, 2020

(30) Foreign Application Priority Data
Jul. 3, 2019 (JP) 2019-124666

(51) Int. Cl. A63F 13/31; A63F 13/537; A63F 13/825; G06Q 20/40

(52) U.S. Cl. CPC A63F 13/31; G06Q 20/401; A63F 13/825; A63F 13/537

(57) ABSTRACT

A computer system manages user registration information including a contract spending amount, and prepares a character associated with character characteristics. The computer system controls virtual communication performed on a user terminal with the character as a partner. The user experiences this virtual communication. The computer system selects a purchase option that costs within the contract spending amount as an article to purchase from purchase options including substantial articles in a real world or items in a virtual world. This selection is performed using at least a purchase article selection tendency based on the character characteristics associated with the character.

### CROSS REFERENCE TO RELATED APPLICATION

This application is based upon and claims the benefit of priority to Japanese Patent Application No. 2019-124666 filed on Jul. 3, 2019, the entire contents of which are incorporated herein by reference.

### BACKGROUND

Video games such as roll playing games (RPG) often include a character whose behavior changes in accordance with a relationship with a user. For example, Japanese Unexamined Patent Application Publication No. 2009-136411 discloses a technique making it possible that a user changes behavior of an opponent character (non-player character [NPC]) by content of a conversation when the user has a text-based conversation (virtual communication) with the opponent character through a player character. In addition to the RPG, a similar technique is also known in a so-called raising game for raising a virtual pet in which pet growth changes according to operations of a player as a pet owner.

In any case, it can be said that the user (the player) enjoys making communication with a character whose behavior changes according to his/her action. The same is true of online games that are mainstreams of recent video games, and the communication with the character is one of major factors making the online games attractive.

Meanwhile, an article purchase system for purchasing an article online is known. With this system, a user can order an article and have it delivered to a designated place without going to an actual shop. For example, Japanese Unexamined Patent Application Publication No. 2002-117295 describes a server that accepts applications for periodic purchase and changes in application details. Moreover, for example, WO 2015/162715 describes a system that generates several plans of periodic purchase based on status of stocking and shipping of a shop and proposes them to a user. Moreover, for example, Japanese Unexamined Patent Application Publication No. 2014-21564 describes a system that automatically performs all procedures of accepting applications of periodic purchase, taking orders, settling payment, and shipping.

A conventional online article purchase system requires a user to perform a selection operation for selecting an article to purchase and to determine to purchase the article at an arbitrary timing desired by the user. This purchase style is the same as the purchase style in the actual shop, though the user does not go to the actual shop. In response to an order made through the article purchase system, the purchased article is delivered in due time to the user by a home delivery service or the like. It is obvious to the user what is delivered. Thus, from a viewpoint of the user, though the user is happy to have purchased a new article, the user is not surprised like receiving an article someone else purchased for the user.

### BRIEF DESCRIPTION OF THE DRAWINGS

FIG. 1 is a diagram illustrating a configuration example of an automatic purchase system.

FIG. 2 is a front view of a configuration example of a user terminal.

FIG. 3 is a diagram illustrating an outline of a service provided by the automatic purchase system.

FIG. 4. is a diagram illustrating an example of communication with a character.

FIG. 5 is a diagram illustrating characteristics of each type of a character.

FIG. 6 is a diagram illustrating a data configuration example of article selection tendency definition data.

FIG. 7 is a diagram illustrating a data configuration example of conversation tendency definition data.

FIG. 8 is a functional block diagram illustrating a functional configuration example of a user terminal according to a first embodiment.

FIG. 9 is a functional block diagram illustrating a functional configuration example of a server system according to the first embodiment.

FIG. 10 is a diagram illustrating an example of programs and data stored in a server storage section according to the first embodiment.

FIG. 11 is a diagram illustrating a data configuration example of user status presumption reference data (part 1).

FIG. 12 is a diagram illustrating a data configuration example of the user status presumption reference data (part 2).

FIG. 13 is a diagram illustrating a data configuration example of user registration information.

FIG. 14 is a diagram illustrating a data configuration example of character management data.

FIG. 15 is a flowchart illustrating a flow of a process in relation to one user in the server system according to the first embodiment.

FIG. 16 is a flowchart continued from FIG. 15.

FIG. 17 is a functional block diagram illustrating a functional configuration example of a user terminal according to a second embodiment.

FIG. 18 is a flowchart illustrating a flow of a process in a server system according to a configuration of a modification example requesting approval for purchase of a user (corresponding to the flowchart in FIG. 15).

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

A first aspect of the present embodiment is

a computer system including at least one processor or circuit programmed to:

manage user registration information of a user,

manage a given character in association with character characteristics of the character wherein the character appears in virtual communication performed by the user with the character as a partner on a user terminal, and

automatically select an article to purchase from a group of purchase option data including accumulated data of purchase options by using at least a purchase article selection tendency based on the character characteristics wherein the purchase options include substantial articles in a real world and/or items in a virtual world.

The “items in the virtual world” are items used in a video game played by the user as a player or in a virtual world on an Internet where the user can act freely using an avatar. For example, the items include a weapon, a protection, medicine, magic, skill, a map, land in the virtual world, an article in the virtual world, a virtual pet, clothes worn by a character, a tool attached to the character, or the like that can be owned or used by the player.

As a result, in the present embodiment, the server system can control the character to provide the user with an experience of the virtual communication (e.g., text-based conversation). Meanwhile, the server system can automatically select an article to purchase from the purchase options based on the character characteristics associated with the character to perform a purchase process. From a viewpoint of the user, the user can have an unconventional experience that the character, which the user comes to like while enjoying the communication, selects an article to purchase in a purchase behavior. As a result, it is possible to implement a new use form of the character that the character, which has been a partner of the communication, takes part in purchase in the real world. Accordingly, new enjoyment in the purchase behavior can be provided.

In accordance with one of some embodiments,

the computer system may be configured such that the at least one processor or circuit is further programmed to

control the character to control execution of the communication.

As a result, in the present embodiment, the server system can control the execution of the communication of the character.

In accordance with one of some embodiments, the server system may be configured such that

managing the given character includes performing a control for changing the character characteristics.

As a result, in the present embodiment, the server system can change the character characteristics for each user.

In accordance with one of some embodiments,

the computer system may be configured such that performing the control for changing the character characteristics includes performing a control for changing the character characteristics based on a communication history.

As a result, in the present embodiment, the server system can change the character characteristics of the character based on the communication history between the user and the character.

In accordance with one of some embodiments,

the computer system may be configured such that the character characteristics include an intimacy degree of the character toward the user.

In this configuration, performing the control for changing the character characteristics may include performing a control for changing the intimacy degree based on the communication history.

The “intimacy degree” indicates a degree of closeness between the user and the character. For example, a parameter for the intimacy degree may be an accumulated time length of use of the character, an accumulated time length of communication, a number of conversations, or the like. The parameter for the intimacy degree may also be a parameter value that is set for the character to represent feelings of the character toward the user (e.g., a parameter value called as an affection degree, a favorability degree, a closeness degree, a loyalty degree, or a reliability degree).

As a result, in the present embodiment, the server system can change the intimacy degree of the character toward the user.

In accordance with one of some embodiments,

the computer system may be configured such that the purchase article selection tendency includes a selection tendency of an article to purchase based on the intimacy degree.

As a result, in the preset embodiment, the server system can change the selection tendency of the article to purchase based on the intimacy degree. Accordingly, a state of the communication between the user and the character eventually affects the selection tendency of the article to purchase.

In accordance with one of some embodiments,

the computer system may be configured such that the at least one processor or circuit is further programmed to

perform a control for giving the character a given item based on an operation input by the user.

In this configuration, performing the control for changing the character characteristics may include performing a control for changing the intimacy degree when the control for giving the item is performed.

As a result, in the present embodiment, the server system can implement a system for giving a present to the character from the user in a form of item giving, so to speak, and thus can change the intimacy degree of the character in accordance with a result of item giving. Accordingly, a form of communication between the user and the character is diversified, which makes the communication with the character more attractive.

In accordance with one of some embodiments,

the computer system may be configured such that performing the control for changing the character characteristics includes performing a control for changing the character characteristics based on a game result of a given game executed on the user terminal.

As a result, in the present embodiment, the server system can change the character characteristics based on the game result of the given game executed on the user terminal.

In accordance with the present embodiment,

the computer system may be configured such that the user registration information includes a contract spending amount of the user.

In this configuration, selecting the article to purchase may include performing a purchase process by selecting a purchase option, a cost of which is within the contract spending amount, as the article to purchase.

As a result, in the present embodiment, automatic purchase of a periodic purchase system can be implemented.

In accordance with one of some embodiments, the computer system may be configured such that performing the control for changing the character characteristics includes performing a control for changing the character characteristics based on a process result of the purchase process.

As a result, in the present embodiment, the server system can change the character characteristics in accordance with the process result of the purchase process, such as what is done, how many article is purchased, when or how often purchased.

In accordance with one of some embodiments, the computer system may be configured such that controlling the execution of the communication includes controlling the communication of the character to cause the character to ask an evaluation of the article purchased through the purchase process.

As a result, in the present embodiment, the server system can acquire information on a user evaluation of the purchased article.

In accordance with one of some embodiments, the computer system may be configured such that performing the control for changing the character characteristics includes performing a control for changing the character characteristics based on the evaluation.

As a result, in the present embodiment, the server system can change the character characteristics based on the evaluation result.

In accordance with one of some embodiments, the computer system may be configured such that controlling the execution of the communication includes controlling the communication of the character to cause the character to report to the user as if the character itself had made a purchase through the purchase process.

As a result, in the present embodiment, the server system can give an impression to the user as if the character itself had made the purchase through the purchase process.

In accordance with one of some embodiments,

the computer system may be configured such that the user registration information includes a contract period set based on a setting operation by the user with a unit period as one unit, and

the contract spending amount is an amount per unit period.

In this configuration, selecting the article to purchase includes performing the purchase process for each passage of the unit period.

As a result, in the present embodiment, the server system can provide an automatic purchase service of a periodic purchase system in a contract period set by the user with the unit period as one unit.

In accordance with one of some embodiments,

the computer system may be configured such that selecting the article to purchase includes performing a purchase process by selecting an article to purchase for the contract spending amount in the unit period corresponding to a current date and time.

As a result, in the present embodiment, the server system selects an article to purchase to spend all the contract spending amount in the unit period.

In accordance with one of some embodiments,

the computer system may be configured such that the at least one processor or circuit is further programmed to

perform a control for giving the user valuable information corresponding to an amount of a balance when a total amount of purchase made through the purchase process during an elapsed unit period is smaller than the contract spending amount after the passage of the unit period.

As a result, in the present embodiment, the server system can give the amount for the balance to the user when the purchased article costs less than the contract spending amount, in other words, when the contract spending amount is not completely used up, when the unit period expires. From another viewpoint, the user does not have to spend all the contract spending amount within the unit period, which increases freedom of selecting an article to purchase. This can reduce a process load related to the purchase. In addition, from a higher viewpoint of continuous unit periods, a purchase amount varies in each unit period.

In accordance with one of some embodiments,

the computer system may be configured such that selecting the article to purchase includes performing the purchase process by adding an amount of the balance to the contract spending amount in a subsequent unit period when the total amount of the purchase made through the purchase process during the elapsed unit period is smaller than the contract spending amount after the passage of the unit period.

As a result, in the present embodiment, the server system can carry forward the amount for the balance to the subsequent unit period when the purchased article costs less than the contract spending amount when the unit period expires.

In accordance with one of some embodiments,

the computer system may be configured such that the user registration information includes profile information of the user, and

the purchase article selection tendency includes a selection tendency of an article to purchase based on the profile information.

As a result, in the present embodiment, the server system can change the selection tendency of the article to purchase in accordance with the profile information of the user. For example, when the profile information includes age of the user, the server system can make it impossible or unlikely to select articles inappropriate for the age of the user. In addition, when the profile information includes a deselection condition of the article to purchase set in the profile information based on an operation input by the user, the server system performs a control for selecting an article to purchase by excluding the purchase options corresponding to the deselection condition. As a result, the server system can avoid purchasing an article unwanted by the user.

In accordance with one of some embodiments,

an automatic purchase system may be configured to include the user terminal of the user, and

the server system.

As a result, in the present embodiment, the automatic purchase system providing the above-described operations and effects can be implemented.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, examples of embodiments of the present disclosure will be described. Note that modes to which the present disclosure is applicable are not limited to the following embodiments.

### First Embodiment

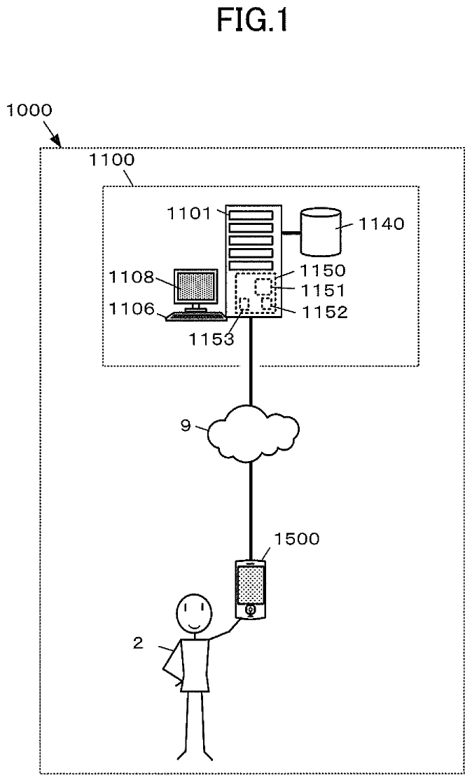

FIG. 1 is a diagram illustrating a configuration example of an automatic purchase system. An automatic purchase system 1000 is a computer system including a server system 1100 and a user terminal 1500 connected via a network 9 to perform mutual data communication and providing a service to allow a user 2 to purchase an article online using the user terminal 1500.

The network 9 is a communication channel capable of data communication. Specifically, the network 9 includes a communication network such as a local area network (LAN) using a private line (a private cable) for direct connection, Ethernet (registered trademark), and the like, a telecommunication network, a cable network, and the Internet. The communication method may be a cable communication method or a wireless communication method.

The server system 1100 includes, for example, a keyboard 1106, a touch panel 1108, and a purchase option data base (DB) 1140. A main body device has a control board 1150. The server system 1100 is a computer system.

The control board 1150 includes a microprocessor of various types (e.g., a central processing unit [CPU] 1151, a graphics processing unit [GPU], or a digital signal processor [DSP]), an integrated circuit (IC) memory 1152 of various types (e.g., a video random-access memory [VRAM], a random-access memory [RAM], or a read-only memory [ROM]), and a communication device 1153. The control board 1150 may be implemented partly or entirely by an application specific integrated circuit (ASIC), a field-programmable gate array (FPGA), or a system on a chip (SoC).

Through a calculation process performed by the control board 1150 based on a predetermined program and data, the server system 1100 implements a function for providing an online article purchase service. This includes providing a program executable on the user terminal 1500 and data required for the execution of the program.

FIG. 1 illustrates only one user terminal 1500, however, a plurality of user terminals 1500 can simultaneously access the server system 1100 in an actual system operation.

FIG. 1 also illustrates the server system 1100 including only one server device, however, the server system 1100 may be implemented by a plurality of devices. For example, the server system 1100 may be configured such that a plurality of blade servers are connected together via an internal bus in a data communicable manner to share the functions. Hardware included in the server system 1100 may be installed anywhere. The server system 1100 may be configured such that a plurality of independent server devices installed at remote places perform data communication via the network 9 to function as the server system 1100 as a whole.

For example, the purchase option DB 1140 is a data base of information on substantial articles in a real world that can be purchased through the automatic purchase system 1000. The purchase option DB 1140 may be located geographically apart from the server system 1100. In addition, for example, when an operator of the automatic purchase system 1000 cooperates with an article provider, the purchase option DB 1140 may be a data base owned by the article provider. A number of purchase option DBs 1140 is not limited to one, but may be plural. In addition, the purchase option DB 1140 may include a mail order website or a reservation website of accommodations or the like if the server system can automatically access the website using an application program interface (API) provided by the website.

According to the present embodiment, the articles included in the purchase option DB 1140 are not limited to the substantial articles in the real world. For example, the articles may be items in a virtual world. The items in the virtual world include an item used in a video game played by a user as a player or an item used in a virtual world on the Internet where the user can act freely using an avatar. For example, the items include a weapon, a protection, medicine, magic, skill, a map, land in the virtual world, an article in the virtual world, a virtual pet, clothes worn by a virtual character, a tool attached to the virtual character, or the like that can be owned or used by the player.

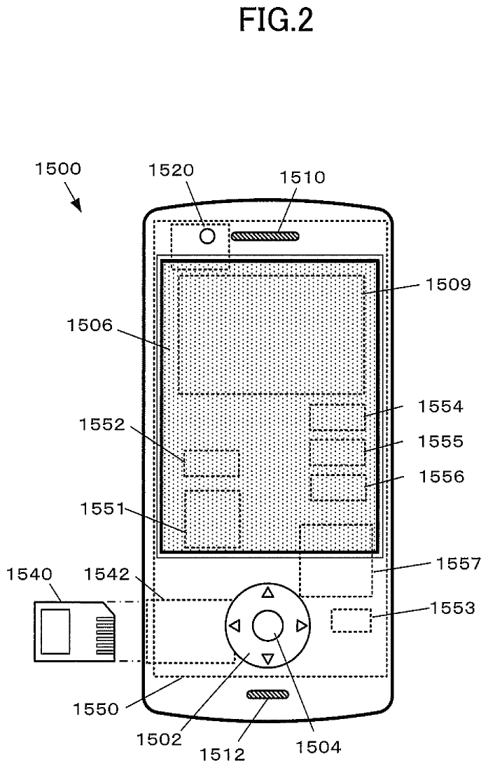

FIG. 2 is a front view of a configuration example of the user terminal 1500.

The user terminal 1500 is a computer system that is used by a registered user for using the automatic purchase system according to the present embodiment, and is an electronic apparatus (an electronic device) that can access the server system 1100 via the network 9. The user terminal 1500 according to the present embodiment is a device known as a smartphone. The user terminal 1500 may also be a wearable computer such as a smartwatch or smartglasses, a portable game device, a tablet computer, a personal computer, or the like. The user terminal 1500 may be constituted of a functionally connected state of a plurality of devices such as a smartphone and a smartwatch establishing communication connection with the smartphone.

The user terminal 1500 includes an arrow key 1502, a button switch 1504, a touch panel 1506 functioning as an image display device and a touch position input device, a built-in battery 1509, a speaker 1510, a microphone 1512, a camera 1520, a control board 1550, and a memory card reader 1542 capable of writing and reading data on and from a memory card 1540 that is a computer readable storage medium. The user terminal 1500 further includes a power button, a volume control button, or the like (not illustrated). Furthermore, the user terminal 1500 may include an IC card reader capable of implementing contactless writing and reading of data on and from an IC card, such as a credit card or a prepaid card, that can be used to pay a cost for the automatic purchase system or the like.

The control board 1550 includes (1) a microprocessor of various types (e.g., a CPU 1551, a GPU, or a DSP), (2) an IC memory 1552 of various types (e.g., a VRAM, a RAM, and a ROM), (3) a wireless communication module 1553 for performing wireless communication with a mobile phone base station, a wireless LAN base station, or the like connected to the network 9, (4) a positioning module 1554, (5) a triaxial acceleration sensor 1555, (6) a triaxial gyro 1556, (7) an interface circuit 1557, or the like.

The positioning module 1554 acquires geographical position information on the user terminal 1500. According to the present embodiment, the positioning module 1554 uses an existing positioning system to acquire position coordinates in a real space. That is, the positioning module 1554 receives signals provided from the positioning system and outputs the positioning information at a predetermined interval (e.g., once a second) so as to provide a positioning function on the user terminal 1500. The present embodiment uses a global positioning system (GPS) as the positioning system. Thus, the positioning module 1554 can use an existing “GPS module” or a “GPS receiver”, or the like. The “positioning information” includes a measurement date and time (e.g., coordinated universal time [UTC]), position coordinates (latitude/longitude/altitude), a direction or the like. The positioning system to be used is not limited to the GPS and can be selected as appropriate. For example, the positioning module 1554 may be replaced with a configuration including a communication device performing wireless connection with a wireless base station of a mobile phone or a Wi-Fi network and a direction sensor. That is, pre-measured position information of a wireless base station to which the user terminal is connected may be acquired, and this information may be considered as the position coordinates of the user terminal 1500 in the real space.

The interface circuit 1557 includes circuits such as a driver circuit that drives the touch panel 1506, a circuit that receives signals from the arrow key 1502 and the button switch 1504, an output amplifier circuit that outputs sound signals to the speaker 1510, an input signal generation circuit that generates signals corresponding to the sound collected by the microphone 1512, or a signal input-output circuit that inputs and outputs signals to and from the memory card reader 1542.

These elements mounted on the control board 1550 are electrically connected with each other via a bus circuit or the like to be capable of exchanging data and signals. The control board 1550 may partially or entirely be implemented with an ASIC, a FPGA, or a SoC. The control board 1550 stores programs and various types of data for implementing a function of the user terminal in the IC memory 1552.

The user terminal 1500 may be configured to download programs and various types of setting data from the server system 1100 in the present embodiment. Alternatively, the user terminal 1500 may be configured to read the programs and the data from a storage medium such as a memory card 1540 separately provided.

The control board 1550 executes a process of continuously recording and managing “behavior history information” of a user, i.e., a life log, in addition to a process related to use of the automatic purchase system. The “behavior history information” includes information on the user such as position history information (a so-called GPS log), play history information of an online game (a so-called gameplay log), online video watching history information, mail order history information via a website, pictures of food taken for calorie control, or a history of a heart rate or blood pressure.

Specifically, the control board 1550 accumulates geographical position information (GPS position coordinates) acquired by the positioning module 1554, measured data by the triaxial acceleration sensor 1555, and measured data by the triaxial gyro 1556 in association with measured time on a time-series basis as the “behavior history information”. The control board 1550 analyzes these information on a time-series basis to accumulates the position history information of the user that tells when and where the user was and how the user moved. When the behavior history information includes a heart rate, blood pressure, body weight, body temperature, or the like, the user terminal 1500 is required as appropriate to include a component such as a wearable computer (e.g., a smart watch) having a sensor for measuring the heart rate, blood pressure, body weight, or body temperature and a communication device, a scale having a sensor and a communication device, or the like.

The video watching history information and the mail order history information may be independently accumulated whenever the respective services are used or may be acquired through the APIs provided by the respective services using previously recorded user accounts and passwords when necessary.

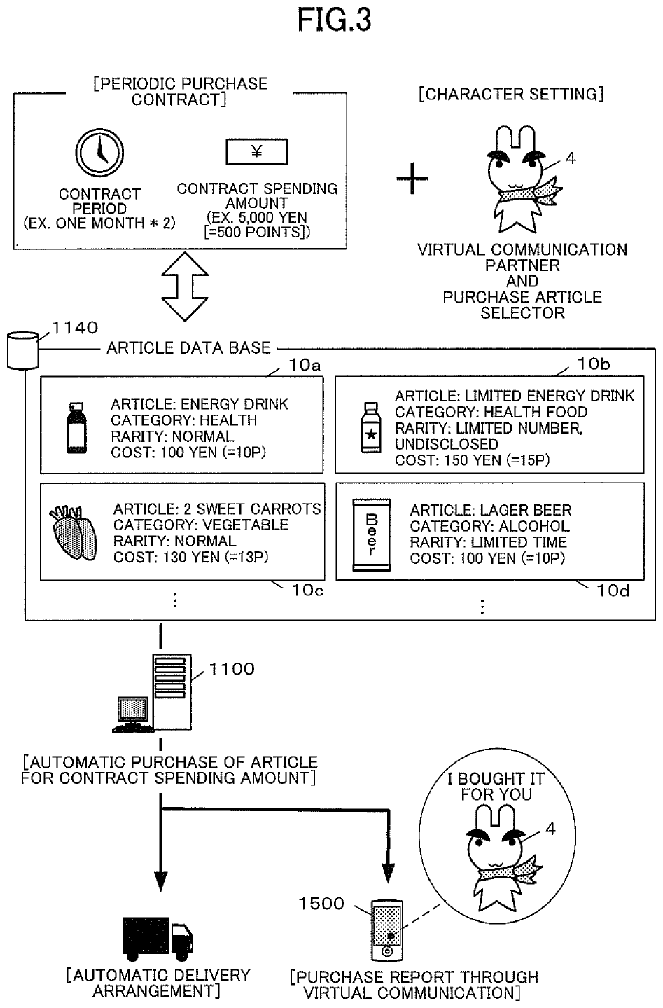

FIG. 3 is a diagram illustrating an outline of the service provided by the automatic purchase system 1000. The automatic purchase system 1000 according to the present embodiment is a system for providing a periodic purchase service of an automatic article selection type with a virtual communication experience. The user makes a contract for the periodic purchase with an operator of the automatic purchase system 1000 beforehand. Contract details include a contract period with an unit period (e.g., ten days or one month) as one unit and a contract spending amount paid per unit period of one unit. For example, when the unit period is one month and the contract spending amount per unit period is 3,000 yen, a contract with the contract period of six months becomes a periodic purchase contract to pay 3,000 yen per month for six months (18,000 yen total).

The “contract spending amount” described herein corresponds to a contract amount and is a cost paid by the user for the article purchase. What is used as the cost can be selected as appropriate in accordance with a setting of a payment method related to the contract. According to the present embodiment, the cost for the periodic purchase is paid by electronic settlement using a credit card registered by the user when making the contract. The contract spending amount is practically the contact amount. In addition, the cost may be paid by virtual currency, a prepaid point, an item separately purchased online, automatically-given point automatically given to a registered user with passage of time, or the like.

The automatic purchase system 1000 automatically purchases an article for the contract spending amount once or several times per unit period of the contract period.

That is, in order to perform a purchase process, the automatic purchase system 1000 performs 1) an automatic article selection process in which the system refers to article-related information 10 (10a, 10b, . . . ) associated with each article among an article group (purchase options) registered in the purchase option DB 1140 and automatically selects an article to purchase within the contract spending amount at a timing autonomously determined without a selection operation by the user, 2) an automatic settlement process in which the system automatically pay the cost for the automatically selected purchase article and a shipping fee without a selection operation by the user, and 3) a delivery arrangement process in which the system automatically arranges the purchased article to be delivered to the user without a selection operation by the user.

The article-related information 10 is prepared for each type of article and includes information usable for the automatic article selection. For example, the article-related information 10 may include an article name, an article category, rarity, a cost for purchase, color, shape, capacity, an expiry date or a freshness date, a country of origin, or ingredients. Contents of the article-related information 10 can be set as appropriate in accordance with an adopted algorithm of the automatic article selection, or options provided for the user 2 to allow the user to reject the purchase (i.e., a restriction on the country of origin, or a restriction on the ingredients, for example).

The automatic purchase system 1000 sets a character 4 for each user as an assistant for the automatic purchase. The character 4 may be designed in a form of a human (e.g., a virtual idol, or a cartoon character), a virtual animal, a robot, an imaginary creature, or the like. It may be set as appropriate. Behavior of the character 4 is controlled to make the character 4 appear to be intelligent enough to perform ordinary communication with the user 2.

The “communication” described herein is virtual communication implemented through the user terminal as a man-machine interface to make the user feel as if the user were communicating with an artificial intelligence. A form of communication is, for example, conversation (any one of text-based conversation and voice conversation), or nonverbal indirect exchange of feelings or will (e.g., body language or a gesture) such as behavior of a pet toward an owner. Any form may be set to suit the design of the character 4 as appropriate.

The automatic purchase system 1000 performs a communication process allowing daily communication between the user 2 and the character 4 regardless of the article purchase.

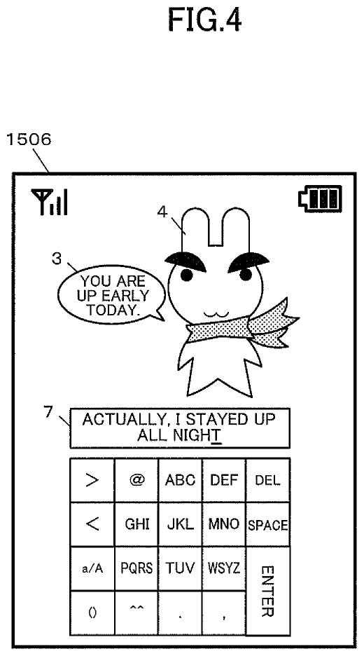

For example, as illustrated in FIG. 4, the automatic purchase system 1000 displays the character 4 on the touch panel 1506 of the user terminal 1500, and controls an action of the character 4 as if the character 4 lived in a display screen. Then, the automatic purchase system 1000 controls the action and behavior of the character 4 such that the character 4 initiates the conversation to invite the user 2 to make communication or the character 4 responds to a conversation operation initiated by the user 2 so as to implement the communication.

In the example in FIG. 4, a remark of the character 4 is displayed in a balloon 3, and the user 2 uses a software keyboard 7 to input his/her remark so as to establish text input/output based conversation.

As described above, the purchased article is delivered to the preregistered place by an existing home delivery system. From a viewpoint of the user 2, the article is unexpectedly delivered one day. Thus, the user 2 can feel joy and pleasure as if to receive a present that someone else voluntarily purchased for the user, which cannot be expected from a conventional online article purchase.

In addition, the automatic purchase system 1000 uses the communication between the character 4 and the user 2 to report after the delivery of the article as if the character 4 itself had selected and purchased the article and had arranged the delivery in secret from the user 2.

Specifically, the automatic purchase system 1000 stores a delivery tracking number acquired during the delivery arrangement process, periodically accesses a delivery tracking website of the home delivery system, and monitors delivery status of an undelivered purchased article for each delivery tracking number through the API or the like provided by the website. Then, when the delivery status of the delivery tracking number becomes delivery-completed status, the automatic purchase system 1000 makes a report and displays an image for inviting the user to input an evaluation of the purchased article on the user terminal 1500.

The user 2 is informed of a source of the unexpectedly delivered article by the character 4 and is also provided with an opportunity to communicate with the character 4 about the purchased article. That is, the user 2 can appreciate not only convenience in the online article purchase, but also surprise as if to receive a present and fun from the communication about the purchased article.

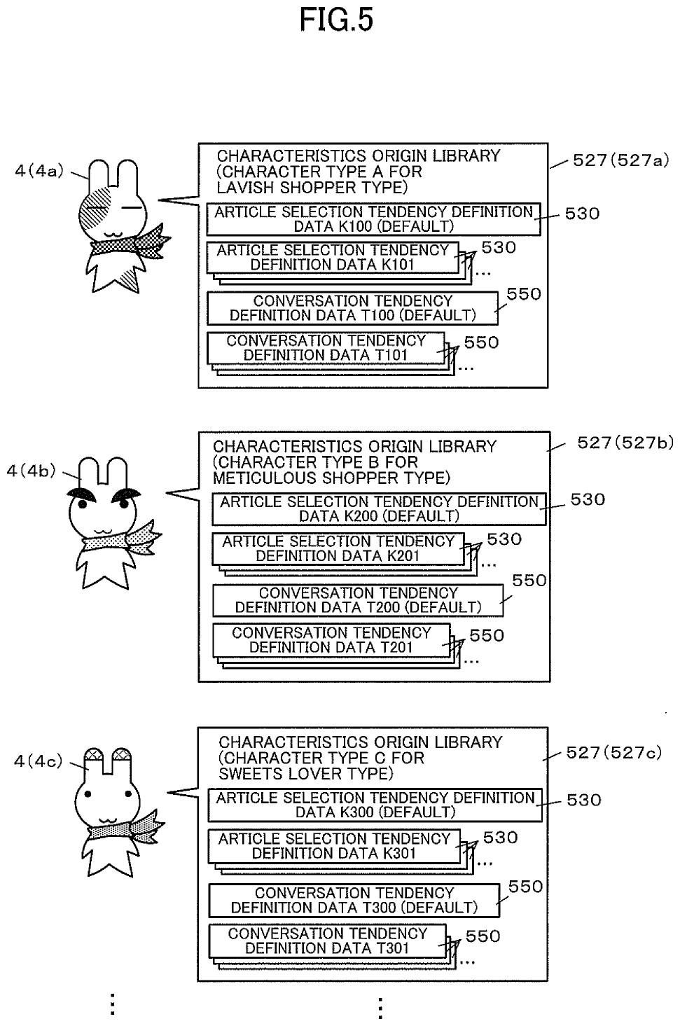

FIG. 5 is a diagram illustrating characteristics of each type of the character 4. The user 2 can select a type of the character 4 to use from a plurality of optional types.

The character 4 is designed to have different characteristics depending on its type.

Specifically, the automatic purchase system 1000 has a characteristics origin library 527 (6a, 6b, . . . ) as a database for each type of the character 4 (4a, 4b, . . . ). One characteristics origin library 527 includes article selection tendency definition data 530 and conversation tendency definition data 550 for each of presumable various situations.

When the user 2 starts using the system, the automatic purchase system 1000 selects and starts applying a default article selection tendency definition data 530 and a default conversation tendency definition data 550 from the characteristics origin library 527 of the character 4 used by the user 2. Then, the automatic purchase system 1000 reselects the tendency definition data suitable for a state or status of the user 2 and a way of the conversation between the user 2 and the character 4 at each time at a given timing so as to use the reselected tendency definition data for the automatic article selection and a conversation control thereafter. Accordingly, the character 4 shows a predetermined characteristics in accordance with the type of the character at the beginning of the use. Then, as the use of the character progresses, though the character maintains an outline of its characteristics, the character gradually shows the characteristics corresponding to a situation at each time in its details. It appears to the user 2 as if the character behaved like a human.

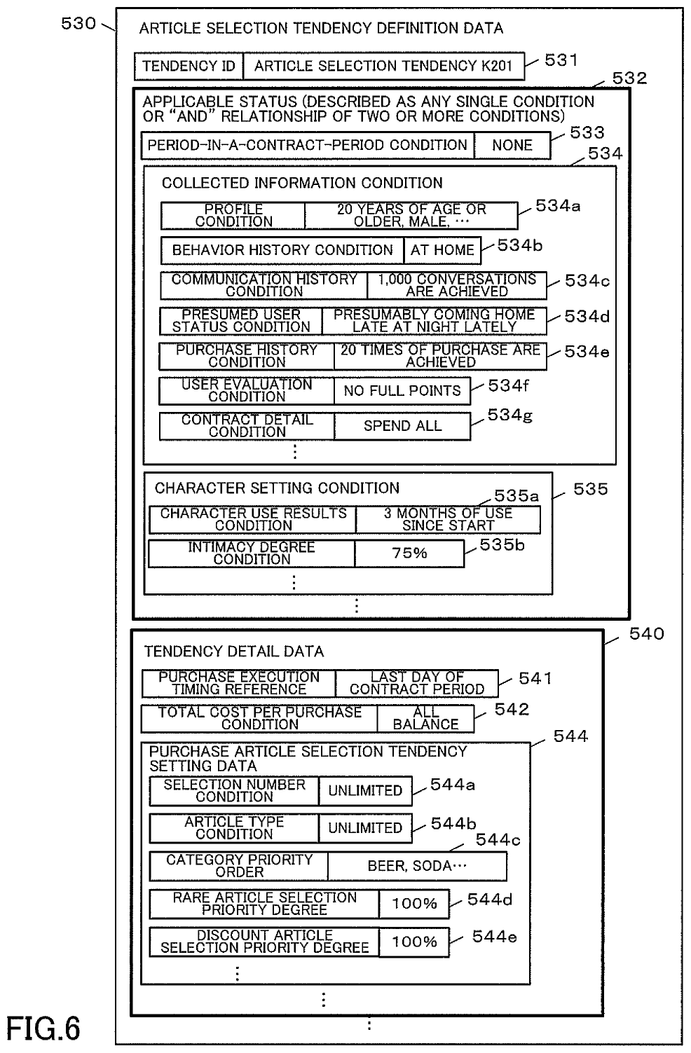

FIG. 6 is a diagram illustrating a data configuration example of the article selection tendency definition data 530.

The article selection tendency definition data 530 includes various types of data defining the tendency and the characteristics of the character 4 related to the article selection. The tendency defined by the article selection tendency definition data 530 is set for each characteristics origin library 527 (see FIG. 5) so as to create different characteristics from the ones in another library. In other words, the article selection tendency is set to include the article selection tendency based on a character setting.

Specifically, one article selection tendency definition data 530 includes a unique tendency ID 531, applicable status 532, and tendency detail data 540.

The applicable status 532 describes the status to be satisfied in order that this definition data is selected and applied to control the character 4. The applicable status 532 includes one condition or a combination of conditions.

Specifically, the applicable status 532 includes a period-in-a-contract-period condition 533, a collected information condition 534, and a character setting condition 535. One or more of the conditions used to describe the applicable status 532 may be omitted and a condition related to another parameter may be added as appropriate. These conditions may be set to be practically unconditional.

The period-in-a-contract-period condition 533 is a condition concerning a temporal relationship of a current date and time relative to the contract period. The period-in-a-contract-period condition 533 may be set to content such as “on the last day of the contract period”, or “in the first half of the contract period”. Whether the condition is satisfied can be determined by comparing a contract starting date and time and a current date and time.

The collected information condition 534 is a condition concerning information automatically collected as information related to the user 2. The “collected information” described herein includes information related to a user registration, behavior history information, a communication history, a presumed result derived from these information, a purchase history, a user evaluation of a purchased article, or the like. The collected information condition 534 is described by one condition or a combination of conditions taking the collected information as a parameter.

Specifically, the collected information condition 534 includes a profile condition 534a, a behavior history condition 534b, a communication history condition 534c, a presumed user status condition 534d, a purchase history condition 534e, a user evaluation condition 534f, and a contract detail condition 534g. Note that other conditions can be included as appropriate.

The profile condition 534a is a condition concerning personal information declared by the user 2 in the user registration. For example, the profile condition 534a includes an address, a name, age, sex, a date of birth, an occupation, a family structure, dates of birth of family members, or the like. The article selection tendency definition data 530 associates the applicable status 532 with the tendency detail data 540, and thus the article selection tendency definition data 530 practically includes the article selection tendency based on the profile information of the user 2.

The behavior history condition 534b is a condition concerning behavior history information automatically recorded and managed in the user terminal 1500, and is described by a parameter of data included in the behavior history information (e.g., a location of the user 2, a moving distance of the user 2, an exercise quantity, a time length of gameplay, or a presumed intake calory value). Specifically, the behavior history condition 534b may be set to content such as “at home”, “at work”, “walked 10,000 steps”, “gameplay for eight hours or more”, or “took too much calories”.

The communication history condition 534c is a condition concerning results of the communication between the user 2 and the character 4, and can be determined from the communication history. The communication history condition 534c may be set to content such as “100 hours of communication (an accumulated time length of communication) is achieved”, or “1,000 conversations (a number of conversations in the communication) are achieved”.

The presumed user status condition 534d is a condition concerning a user state or status presumed from the collected information and the automatically collected information acquired by automatically circulating around websites based on the collected information.

Specifically, the automatic purchase system 1000 specifies a geographical behavior range (e.g., a name on a map or a name of a railway line) of the user 2 on a day from the history of the position information in the behavior history. With a specified result as a key, the automatic position information system 1000 then acquires current news such as a traffic condition, an incident, an accident, weather, or temperature in the behavior range by circulating around the websites. Thus, the presumed user status condition 534d may be set to content such as “caught in a thunderstorm”, “caught in a traffic jam”, or “the highest temperature in the day was over 35 degrees Celsius”.

Moreover, the automatic purchase system 1000 analyzes content of the communication and presumes that the user 2 is tired if a keyword such as “tired”, “exhausted”, “stayed up all night”, or “do not want to eat” is included. If a word “hospital” or a word of a symptom of a disease is included in the keyword, it is possible to presume that the user 2 is sick. Thus, the presumed user status condition 534d may be set to an analysis result such as “presumably tired”, or “presumably sick”.

Moreover, when the behavior history includes the information on the play history of gameplay, the automatic purchase system 1000 can tell how long the user performs the gameplay. Thus, the presumed user status condition 534d may be set to content such as “gameplay of more than eight hours a day (too much gameplay)”.

Moreover, when the behavior history includes intake calories (or image data or a name of food eaten by the user that can be used for estimating the intake calories), the automatic purchase system 1000 can tell eating habits of the user 2. Thus, the presumed user status condition 534d may be set to content such as “intake calories in a day exceed (a reference value)”, or “lack of (a name of a nutritional composition)”.

The purchase history condition 534e is a condition concerning the purchase history, and is also a condition concerning an experience value of the character 4 as the assistant for the automatic purchase. The automatic purchase system 1000 stores the purchase history for each user, which will be described later. Thus, the purchase history condition 534e may be set to content such as “100 kinds of articles are purchased in total”, or “100 times of purchase are achieved in total”.

The user evaluation condition 534f is a condition concerning the evaluation of the purchased article by the user 2, and is also a condition concerning a result of article selection by the character 4. The automatic purchase system 1000 stores the purchase history in association with the information on the user evaluation of the purchased article. Thus, the user evaluation condition 534f may be set to content such as “an average evaluation is less than three points out of five points”, or “no full five points for (a past predetermined period)”.

The contract detail condition 534g is a condition concerning contract details and is described based on settings (described later) such as a length of contract period, a contract spending amount, or how to handle a balance of the contract spending amount, using ranges or thresholds of these settings.

The character setting condition 535 is a condition concerning a setting of the character 4 and includes, for example, a character use results condition 535a and an intimacy degree condition 535b. Note that other types of data can be included as appropriate.

The character use results condition 535a is a condition concerning a length of time of a relationship between the user 2 and the character 4 and results of the character 4 as the assistant. The character use results condition 535a may include elapsed time since a start of the automatic purchase contract, or access time to the automatic purchase system 1000, or the like. The automatic purchase system 1000 can tell how many times the contract is automatically renewed from the elapsed time from the start of the automatic purchase contract and the contract period. Thus, the character use results condition 535a may be set to content such as “three months of use since a start”, “100 hours of use is achieved”, or “automatic renewal of three times or more”.

The character use results condition 535a may be replaced with a character experience value, character growth level, or the like. In such a case, the character experience value and the character growth level are automatically updated or changed as part of a control related to a character management based on a length of time of the use of the character or the communication history (specifically, content of the conversation).

The intimacy degree condition 535b is a condition concerning an “intimacy degree” which is one of parameters related to the setting of the character 4. Details will be described later. The automatic purchase system 1000 changes the intimacy degree based on the communication history, the evaluation result of the purchased article, or the like at a given timing.

The tendency detail data 540 is what the article selection tendency definition data 530 defines, and at least one tendency detail data 540 is prepared for each definition data. The tendency detail data 540 includes a purchase execution timing reference 541, a total cost per purchase condition 542, and purchase article selection tendency setting data 544.

The purchase execution timing reference 541 is a condition to be satisfied to execute the automatic purchase. For a parameter of the purchase execution timing reference 541, the parameters adopted in relation to the conditions of the applicable status 532 can be used. Thus, the purchase execution timing reference 541 may be set to content such as “every passage of a unit period”, “Saturday or Sunday”, “national holiday”, “next day of a preregistered payday”, “tired”, “birthday”, or “when stayed home all day long”. The purchase execution timing reference 541 may also be set to a time period of a day such as “in the morning”, or “in the night”. Moreover, the purchase execution timing reference 541 may also be set using a balance of the contract spending amount, such as “a remaining contract period is less than three days and a balance is 50% or more of the contract spending amount”.

The characteristics origin library 527 is prepared for each type of the character 4, and the applicable status 532 includes the conditions concerning the character setting related to the character characteristics of the character 4 such as the character use results condition 535a and the intimacy degree condition 535b. Accordingly, it can be said that the purchase execution timing reference 541 includes a timing reference based on the character setting of the character 4.

Any number of purchase execution timing references 541 may be included in each article selection tendency definition data 530. Thus, for example, in order to set characteristics that cause the character to daringly purchase only once in the contract unit period using all of the contract amount for a unit period of the periodic purchase, only one purchase execution timing reference 541 such as “last day of the contract unit period” is required to be prepared.

The total cost per purchase condition 542 is a condition concerning a budget for each automatic purchase, and may be set using a predetermined value or a range of a spendable contract spending amount, or a percentage of the spendable contract spending amount to the contract amount per unit period. The total cost per purchase condition 542 may be set to “all”.

The purchase article selection tendency setting data 544 includes data of various types defining the tendency in selecting the article to purchase from article groups of a plurality of types. Paradoxically, it can be said that the purchase article selection tendency setting data 544 defines a restriction and a premise for the selection. Considering that the applicable status 532 includes the intimacy degree condition 535b, it can be said that the selection tendency defined by the article selection tendency definition data 530 includes the selection tendency of the article to purchase based on the intimacy degree.

Specifically, the purchase article selection tendency setting data 544 includes, for example, a selection number condition 544a, an article type condition 544b, a category priority order 544c, a rare article selection priority degree 544d, and a discount article selection priority degree 544e. Note that other types of data can be included as appropriate. For example, the purchase article selection tendency setting data 544 may include a popular article priority degree in order that a popular article is preferentially selected. The popular article can be found by cross-searching purchase histories of all users.

The selection number condition 544a is a condition concerning a total number of articles to be selected per purchase. The selection number condition 544a may be set to content such as “one”, “one to five”, “three or more”, or “unlimited (practically corresponding to no condition)”.

The article type condition 544b is a condition concerning a type of the article to be selected per purchase. The article type condition 544b may be set to content such as “one type”, “a plurality of types”, or “unlimited”.

The category priority order 544c indicates a selection priority order based on an article category for the article selection. The article category is included in management information related to each article in the article groups, and thus this information is referred to for the article selection. The category priority order 544c is implemented in a form of a list that lists categories in a priority order or a list that associates types of categories with priority orders, for example. At this time, setting all the priority orders to “1” can create an article selection tendency practically unaffected by the priority orders of the categories.

The rare article selection priority degree 544d indicates a degree to preferentially select an article with an article category set to “limited” or “undisclosed (meaning that existence is not disclosed to the user)”. When a random lottery determines whether a limited or undisclosed article is preferentially selected in the article selection, the rare article selection priority degree 544d may be described by a wining probability. In such a case, setting the rare article selection priority degree 544d to “100%” creates a setting that an article with the article category of “limited” or “undisclosed” is always selected preferentially. Setting the rare article selection priority degree 544d to “50%” creates a setting of the tendency that the limited or undisclosed article is sometimes selected (at a ratio of 50%). Setting the rare article selection priority degree 544d to a value lower than 50% creates a setting of the tendency that the limited or undisclosed article is barely selected.

That is, it can be said that the tendency detail data 540 defined by the article selection tendency definition data 530 includes definition information on the article selection tendency related to a rarity condition of the article to be selected.

The discount article selection priority degree 544e indicates a degree to preferentially select an article with an article category set to “discount”. When a random lottery determined whether a discount article is preferentially selected in the article selection, the discount article selection priority degree 544e may be described by a wining probability. In such a case, setting the discount article selection priority degree 544e to “100%” creates a setting that an article in the article category of “discount” is always selected preferentially. Setting the discount article selection priority degree 544e to “50%” creates a setting of the tendency that the discount article is sometimes selected (at a ratio of 50%). Setting the discount article selection priority degree 544e to a value lower than 50% creates a setting of the tendency that the discount article is barely selected.

Properly setting the setting of the applicable status 532 and the tendency detail data 540 of the article selection tendency definition data 530 allows the character 4 to have various article selection tendencies in accordance with various situations that the character 4 or the user 2 is in. A synergistic effect of the settings of the status and tendency and the design of the character allows the character 4 to appear as if the character 4 had some sort of intelligence to have a distinctive manner of purchase.

For example, the article selection tendency definition data 530 is prepared with definition data as described below. That is, the contract detail condition 534g is set to “spend all” and other conditions in the collected information condition 534 are set to “unlimited”, the purchase execution timing reference 541 is set to “last day of the contract period”, the total cost per purchase condition is set to “all the balance”, the selection number condition 544a is set to “unlimited”, and the article type condition 544b is set to “unlimited”.

When such an article selection tendency definition data 530 is applied, the character 4 performs the article selection to spend all the contract spending amount on the last day of the contract period.

Moreover, a setting value of the purchase article selection tendency setting data 544 may be set in a wider range as appropriate so that the automatic purchase system 1000 may determine a value to be actually applied from the wider range of the setting value at random when selecting an article. Such a configuration causes moderate selection tendency and fluctuation based on the setting of the “characteristics” in the selection of the article to purchase. Accordingly, the automatic purchase system 1000 can show the character as if the character 4 with a unique personality was selecting the article, or a humanlike intelligent body was selecting the article.

Thus, the article selection tendency definition data 530 has a property as one of personality definition data defining the “personality” of the character 4 of the type associated to this definition data through an action of selecting the article. Accordingly, it is possible to show the character as if its “personality” gradually changed, depending on the setting of the applicable status 532.

Specifically, with regard to the user evaluation condition 534f, for example, two types of applicable status 532 such as “ten or more highest evaluations are not achieved in a row” or “ten or more highest evaluations are achieved in a row” are prepared. Then, in the article selection tendency definition data 530 including the applicable status 532 including the condition set to “ten or more highest evaluations are not achieved in a row”, the tendency detail data 540 is set to a pattern of repeating purchase of a small amount. On the contrary, in the article selection tendency definition data 530 including the applicable status 532 including the condition set to “ten or more highest evaluations are achieved in a row”, the tendency detail data 540 is set to a pattern of rapidly repeating purchase of a large amount. In this example, it is possible to present the character 4 having a personality that is deliberate at first and then makes a daring purchase after being praised continuously.

This presentation of individuality, characteristics, and personality of the character 4 using the settings of the applicable status and the corresponding tendency is also applied to the tendency related to the communication (specifically, the conversation with the character 4).

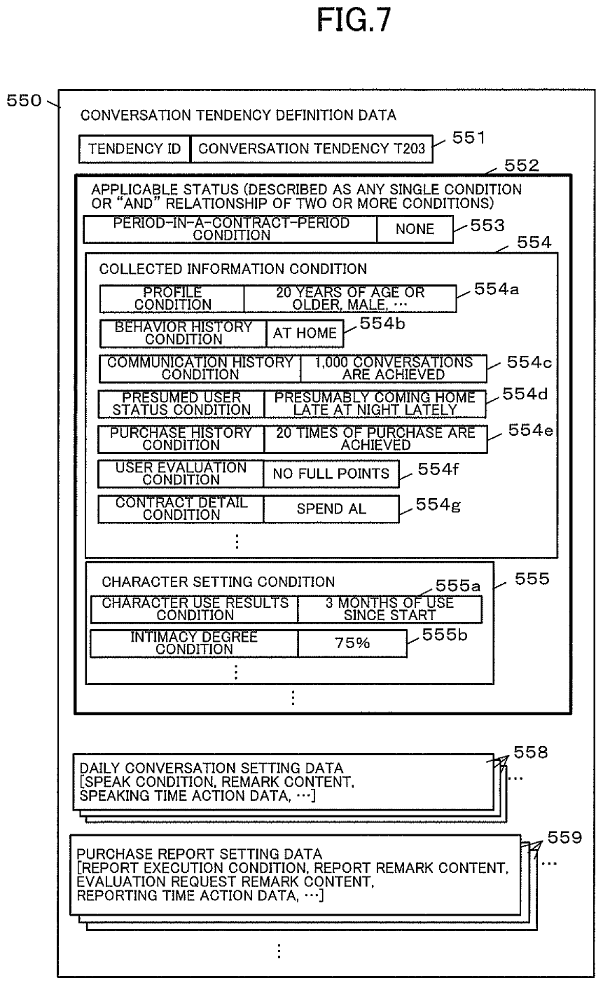

FIG. 7 is a diagram illustrating a data configuration example of the conversation tendency definition data 550.

The conversation tendency definition data 550 includes a unique tendency ID 551, applicable status 552, daily conversation setting data 558, and purchase report setting data 559. Note that other types of data can be included as appropriate.

The applicable status 552 may be described similarly to the applicable status 532 in the article selection tendency definition data 530.

The daily conversation setting data 558 defines a remark or the like of the character 4 in the conversation in ordinary communication. One daily conversation setting data 558 includes a speak condition that is a condition to cause a remark in this data to be spoken, remark content (text or sound data), speaking time action data that defines an action of the character 4 when the character 4 is speaking. Note that other types of data can be included as appropriate.

The purchase report setting data 559 defines a remark that is used for a purchase report to be made through the communication after the delivery of the purchased article is completed. One purchase report setting data 559 includes a report execution condition, report remark content, evaluation request remark content, and reporting time action data. Note that other types of data can be included as appropriate.

The report execution condition is a condition concerning a timing to perform the report, and may be set as appropriate. For example, the report execution condition may be set to a time period of a day such as “in the morning”, “in the evening and later”, or “late at night”.

The report remark content is content of the remark to report the purchase. The remark is an element to show the personality of the character 4, and thus the remark is preferably set in consideration of conformity with an appearance of the character 4.

The evaluation request remark content is content that the character 4 asks the user the evaluation of the purchased article and invites the user to input the evaluation. The input evaluation is used for changing the setting of the character 4. This change is fed back as the tendency of the article to be selected or the conversation through the selection of the article selection tendency definition data 530 or the conversation tendency definition data 550.

Meanwhile, the conversation tendency definition data 550 that omits setting the purchase report setting data 559 is also prepared. The character 4 applied with the conversation tendency definition data 550 that omits setting the purchase report setting data 559 does not perform the purchase report. In other words, the character 4 can be given the characteristics to “skip” the purchase report. Alternatively, it is possible to prepare the conversation tendency definition data in which the purchase report setting data 559 is set, but a report frequency setting (e.g., one-tenth probability) is included. Then, a random lottery with the probability set to the report frequency setting may determine whether to cause the character to perform the purchase report, whenever the server system 1100 is required to execute the purchase report. In this case, the frequency of “skipping” or “forgetting” the report may be varied depending on the type of the character.

Thus, the conversation tendency definition data 550 has a property as one of personality definition data defining the “personality” of the character 4 of the type associated to this definition data through the content of the conversation and the action during the conversation. Accordingly, it is possible to show the character as if its “personality” gradually changed, depending on the setting of the applicable status 552.

Specifically, with regard to the communication history condition 554c, for example, two types of applicable status 552 such as “1,000 conversations are not achieved” and “1,000 conversations are achieved” are prepared. Then, in the conversation tendency definition data 550 including the applicable status 552 including the communication history condition 554c set to “1,000 conversations are not achieved”, the remark content in the daily conversation setting data 558 is set to content including a few words or short sentences to cause the character to speak inarticulately. On the contrary, in the conversation tendency definition data 550 including the applicable status 552 including the communication history condition 554c set to “1,000 conversations are achieved”, the remark content in the daily conversation setting data 558 is set to content that causes the character to speak eloquently (e.g., content that causes the character to speak briskly with a personal pronoun in a sentence). In this example, it is possible to show the character as if the character removed an emotional wall and suddenly became talkative once the communication between the user 2 and the character 4 exceeds a certain threshold.

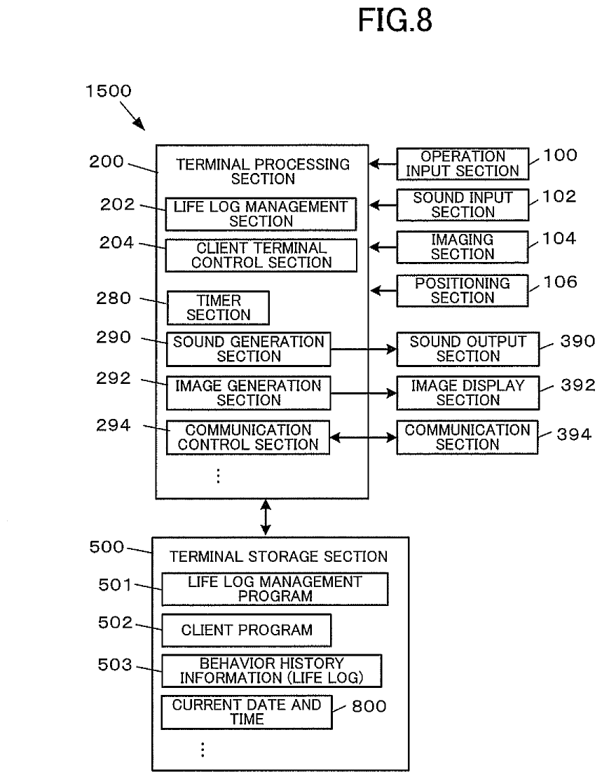

FIG. 8 is a functional block diagram illustrating a functional configuration example of the user terminal 1500 according to the present embodiment. The user terminal 1500 includes an operation input section 100, a sound input section 102, an imaging section 104, a positioning section 106, a terminal processing section 200, a sound output section 390, an image display section 392, a communication section 394, and a terminal storage section 500.

The operation input section 100 outputs operation input signals to the terminal processing section 200 in accordance with various operation inputs by the user. The operation input section 100 can be implemented, for example, by a push switch, a joystick, a touch pad, a track ball, an accelerometer, a gyro, or a charge-coupled device (CCD) module. The operation input section 100 corresponds to the arrow key 1502, the button switch 1504, and the touch panel 1506 in FIG. 2.

The sound input section 102 collects voice emitted by the user 2, and outputs sound signals to the terminal processing section 200. The sound input section 102 corresponds to the microphone 1512 in FIG. 2. When the communication is performed by sound input, the sound input section 102 is used as a second operation input section.

The imaging section 104 generates captured image data and outputs the image data to the terminal processing section 200. The imaging section 104 corresponds to the camera 1520 in the example in FIG. 2. When the behavior history information includes a record of calories of food eaten by the user, the imaging section 104 is used as a third operation input section for photographing and inputting the food eaten by the user.

The positioning section 106 receives a radio wave or the like from a positioning system, generates the position information, and outputs the position information to the terminal processing section 200. The positioning section 106 corresponds to the positioning module 1554 in the example in FIG. 2. When the behavior history information includes the position information, the positioning section 106 is used.

The terminal processing section 200 is implemented, for example, by a microprocessor such as a CPU or a GPU and electronic components such as an IC memory. The terminal processing section 200 controls input/output of data between the functional sections including the operation input section 100 and the terminal storage section 500. The terminal processing section 200 executes various calculation processes based on a predetermined program or data, operation input signals from the operation input section 100, and various types of data received from the server system 1100 to control the operations of the user terminal 1500. The terminal processing section 200 corresponds to the control board 1550 in FIG. 2.

The terminal processing section 200 according to the present embodiment includes a life log management section 202, a client terminal control section 204, a timer section 280, a sound generation section 290, an image generation section 292, and a communication control section 294.

The life log management section 202 controls recording and managing the behavior history information, or the life log. The life log management section 202 is implemented by an application program separate from the automatic purchase system 1000. For example, the life log management section 202 is implemented by an application program for automatically recording a daily behavior range and a destination, an application program for playing an online game, an application program for estimating intake calories and consumed calories, and the like.

The client terminal control section 204 performs various types of control to cause the user terminal 1500 to function as a user terminal for the automatic purchase system 1000. Specifically, the client terminal control section 204 implements a function as a client device communicating with the server system 1100, and a function as a man-machine interface for experiencing a virtual communication with the character 4.

The timer section 280 uses a system clock to measure a current date and time, a limited time period, or the like.

The sound generation section 290 is implemented, for example, by a processor such as a digital signal processor (DSP) or a sound synthesizing IC, or an audio codec for playing a sound file. The sound generation section 290 generates sound signals for music, sound effects, or various types of operational sounds, and outputs the signals to the sound output section 390.

The sound output section 390 is implemented by a device that outputs (emits) sounds based on the sound signals input from the sound generation section 290. The sound output section 390 corresponds to the speaker 1510 in FIG. 2.

The image generation section 292 controls generating image data of various types, and generating and outputting image signals for displaying the images to the image display section 392.

The image display section 392 displays various images based on the image signals input from the image generation section 292. For example, the image display section 392 can be implemented by an image display device such as a flat panel display, a projector, or a head-mounted display. The image display section 392 corresponds to the touch panel 1506 in FIG. 2 according to the present embodiment.

The communication control section 294 performs data processing related to data communication, and implements data exchange with an external device through the communication section 394.

The communication section 394 connects to the network 9 to implement communication. For example, the communication section 394 is implemented by a transceiver, a modem, a terminal adaptor (TA), a jack for wired communication cable, a control circuit, or the like. The communication section 394 corresponds to the wireless communication module 1553 in FIG. 2.

The terminal storage section 500 stores programs and various types of data for causing the terminal processing section 200 to implement given functions. The terminal storage section 500 is also used as a work area for the terminal processing section 200, and temporarily stores results of calculations executed by the terminal processing section 200 in accordance with various programs, input data input from the operation input section 100, or the like. These functions are implemented by an IC memory such as a RAM or a ROM, a magnetic disc such as a hard disc, an optical disc such as a compact disc read-only memory (CD-ROM) or a digital versatile disk (DVD). The terminal storage section 500 corresponds to the IC memory 1552 and the memory card 1540 included in the control board 1550 in FIG. 2. The terminal storage section 500 may be implemented by an online storage.

Specifically, the terminal storage section 500 stores a life log management program 501 for causing the terminal processing section 200 to function as the life log management section 202, a client program 502 for causing the terminal processing section 200 to function as the client terminal control section 204, behavior history information 503 (a life log), and a current date and time 800. Note that other types of data can be stored as appropriate.

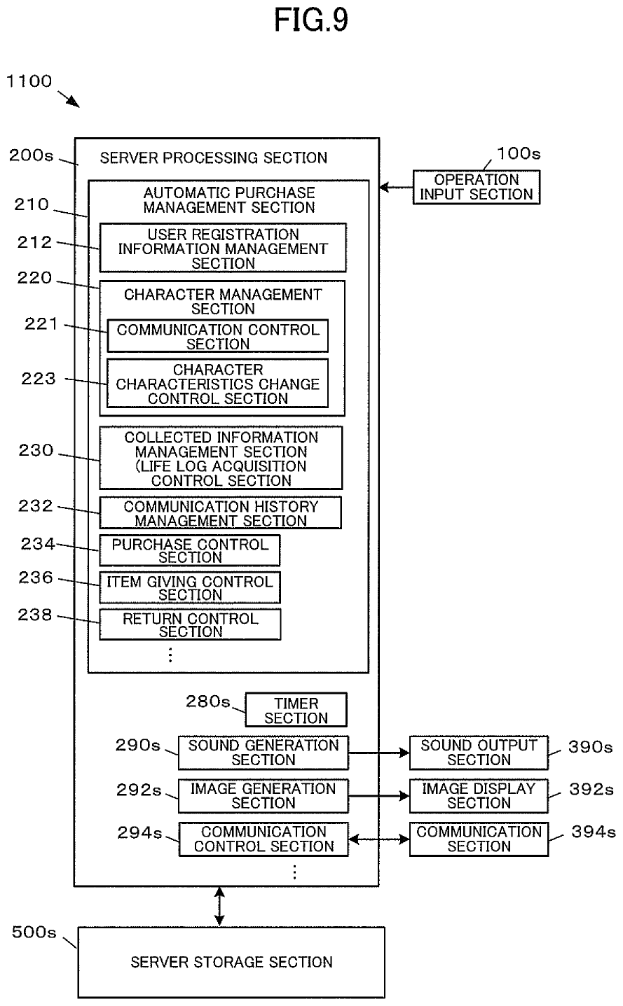

FIG. 9 is a functional block diagram illustrating a functional configuration example of the server system 1100.

The server system 1100 includes an operation input section 100s, a server processing section 200s, a sound output section 390s, an image display section 392s, a communication section 394s, and a server storage section 500s.

The operation input section 100s is a means for inputting various operations for server management. The operation input section 100s corresponds to the keyboard 1106 in FIG. 1.

The server processing section 200s is implemented, for example, by a processor that is a calculation circuit such as a CPU, a GPU, an ASIC, or a FPGA and an electronic component such as an IC memory. The server processing section 200s controls input and output of data between functional sections including the operation input section 100s and the server storage section 500s. The server processing section 200s performs various calculation processes based on predetermined programs and data, operation input signals from the operation input section 100s, data received from the user terminal 1500, or the like to entirely control the operations of the server system 1100.

The server processing section 200s includes an automatic purchase management section 210, a timer section 280s, a sound generation section 290s, an image generation section 292s, and a communication control section 294s. Note that any other functional sections may be included as appropriate.

The automatic purchase management section 210 implements functions performed by the server system 1100 in the automatic purchase system 1000. Specifically, automatic purchase management section 210 includes a user registration information management section 212, a character management section 220, a collected information management section 230, a communication history management section 232, a purchase control section 234, an item giving control section 236, and a return control section 238.

The user registration information management section 212 manages the user registration information including a contract spending amount and a shipping address of a purchased article for each user. Specifically, the user registration information management section 212 sets the contract spending amount of the user based on a setting operation by the user.

The character management section 220 manages an artificial intelligence (AI) character that becomes a partner of the user in the virtual communication performed using the user terminal of the user as the man-machine interface for each user. The character management section 220 includes 1) a communication control section 221 that controls an action of the character 4 during the communication, specifically, conversation and behavior during the conversation, and 2) a character characteristics change control section 223 that controls changing the character setting of the character 4 for each user.

When the purchase process is performed, the communication control section 221 controls the character serving as the partner of the user 2 in relation to the purchase process to report to the user as if the character 4 itself had made the purchase through the purchase process.

Specifically, the communication control section 221 selects purchase report setting data, the report execution condition of which satisfies the status at the time, from the purchase report setting data 559 of the conversation tendency definition data 550, and causes the character 4 to speak using the report remark content of the selected setting data.

As described above, the characteristics origin library 527 includes the conversation tendency definition data 550 omitting the purchase report setting data 559. Accordingly, the communication control section 221 variably controls whether the character performs the report based on the character setting of the character 4 whenever the purchase process is performed.

The report remark content includes content that the character 4 asks the evaluation of the purchased article. Thus, after the purchase process is performed, the communication control section 221 controls the character 4 serving as the partner of the user 2 in relation to the purchase process to ask the evaluation of the article purchased in this purchase process to acquire the evaluation result.

The character characteristics change control section 223 controls changing the character characteristics for each user. Specifically, the character characteristics change control section 223 controls changing the character setting of the character 4 based on the communication history. An “intimacy degree” parameter used for determination of the intimacy degree condition 535b (see FIG. 6) included in the applicable status 532 in the article selection tendency definition data 530 is one of character settings subjected to this change control.

The character characteristics change control section 223 also controls changing the character setting of the character 4 involved in the automatic purchase of the purchased article based on the evaluation result of the purchased article. Specifically, the character characteristics change control section 223 changes a value of the “intimacy degree” parameter managed for each character 4 to raise the intimacy degree when the evaluation result is higher than a predetermined reference value and to lower the intimacy degree when the evaluation result is below the reference value. The “reference value” and a change quantity provided for the change in the intimacy degree described herein are defined with predetermined values different for each type of the character 4, which is an element to cause the user to feel difference in the type of the character 4.

The collected information management section 230 manages automatic collection and record of the collected information related to the user including at least the communication history that is a history of virtual communication for each user.

Specifically, the collected information management section 230 acquires a copy of the behavior history information 503 (the life log) from the user terminal 1500 at a given timing. Thus, the collected information management section 230 has a function as a life log acquisition control section that acquires the life log of each user from the user terminal.

Moreover, the collected information management section 230 automatically circulates around websites based on the acquired behavior history information 503 (the life log) to automatically collect the information for presuming the state or status of the user. As an example of the automatic collection, the collected information management section 230 specifies a current position and moving route of the user from the acquired behavior history information 503 (the life log), and determines an area name including the current position and the moving route. Then, the collected information management section 230 uses the determined area name as a search word to acquire weather information in this area from a predetermined website concerning a weather forecast or a live weather commentary. Moreover, the collected information management section 230 uses the determined area name as a search word to acquire information on a traffic jam or train delay in this area from a predetermined website concerning traffic information.

The communication history management section 232 manages the communication history that is a history of the virtual communication for each user.

The purchase control section 234 performs the automatic article selection process for automatically selecting an article to purchase, the cost of which is within the contract spending amount of the user, using at least the article selection tendency based on the communication history of the user 2 from a given purchase option DB 1140 for each user 2, and the delivery arrangement process for sending the purchased article to the shipping address registered by the user 2 so as to perform the purchase process. Then, the purchase control section 234 records and manages the purchase history.

Specifically, the purchase control section 234 variably determines a number and a combination of purchased articles to be selected for each user.

Then, the purchase control section 234 variably controls an execution timing of the purchase process based on the purchase execution timing reference based on the communication history. As described above, the article selection tendency definition data 530 stores the applicable status 532 and the tendency detail data 540 in an associated manner (see FIG. 6). The applicable status 532 includes the communication history condition 534c indicating the status for application. The tendency detail data 540 includes the purchase execution timing reference 541. Thus, the purchase control section 234 variably controls the execution timing of the purchase process based on the communication history.

Moreover, one of the purchase execution timing reference 541 is set to “at every passage of a unit period”. When this purchase execution timing reference is adopted, the purchase control section 234 performs the purchase process for every passage of the unit period.

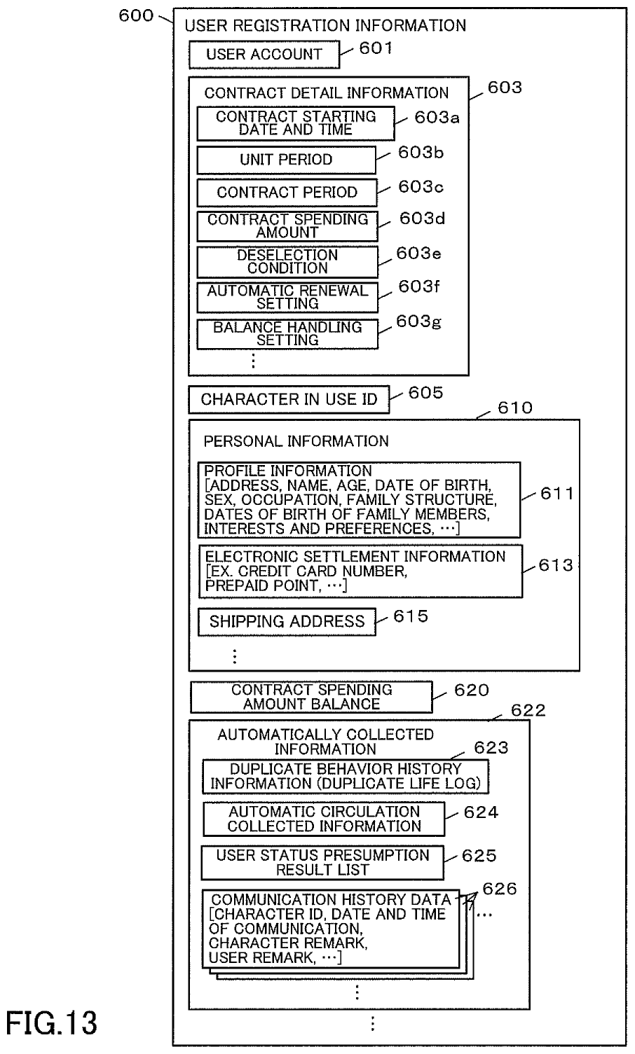

Furthermore, the purchase control section 234 performs a control related to the contract details in accordance with the setting of handling of the balance of the contract spending amount (see a balance handling setting 603g in FIG. 13).

Specifically, assume that the setting of the handling of the balance indicates “carry-forward”. When the total amount of the purchase made through the purchase process during an elapsed unit period is smaller than the contract spending amount after the passage of a unit period, the purchase control section 234 performs the purchase process by adding the amount of the balance to the contract spending amount in the subsequent unit period.

The item giving control section 236 controls giving a given item to the character 4 serving as the partner of the user based on an operation input by the user. The “item” described herein is an item for the character designed to be used by the character 4. The item may include, for example, clothes of the character 4, equipment, food for the character 4, household effects or a collection item owned by the character 4. The user makes a predetermined operation for equipping the character 4 with a separately acquired item by the user 2 to implement item giving. The item may be acquired, for example, in relation to a game played on the user terminal 1500 or may be purchased by mail order executed on the user terminal 1500. Such information is included in the behavior history information.

When the total amount of the purchase made through the purchase process during an elapsed unit period is smaller than the contract spending amount after the passage of the unit period of one unit, the return control section 238 performs a control for giving the user valuable information corresponding to the amount of the balance.

The handling of the balance is set by the user when the use sets the contract by performing a selection operation for selecting any one of options such as “return”, “carry forward”, and “spend all (i.e., spend all to avoid the balance)”. The return control section 238 performs a control when it is set to “return”. Giving the valuable information may be implemented, for example, by returning a medium used to pay the contract spending amount, giving a coupon ticket, or giving an article or an item for the character.

The timer section 280s uses a system clock to measure the current date and time, a limited time period, and others.

The sound generation section 290s is implemented by execution of an IC or software for generating sound data and decoding, and generates or decodes sound data of operational sounds related to system management of the server system 1100, or the like. In the configuration that the sound for reading the remark of the character 4 is emitted on the user terminal 1500, the sound generation section 290s may decode the sound data of the remark. The sound generation section 290s outputs sound signals related to the system management to the sound output section 390s.

The sound output section 390s emits sound in accordance with the input sound signals. The sound output section 390s corresponds to a speaker (not illustrated) included in the main body device or the touch panel 1108 in the example in FIG. 1.

The image generation section 292s generates images, composites images, and outputs image signals to be displayed on the image display section 392s. According to the present embodiment, the image generation section 292s is partly in charge of functions for generating various still images and video images such as images related to the system management of the server system 1100 and data for displaying the character 4 on the user terminal 1500. The image generation section 292s performs rendering an image of the character 4 captured by a virtual camera arranged in a virtual three-dimensional space. Alternatively, rendering the image of the character 4 may be performed on the user terminal 1500. In such a case, the image generation section 292s may omit a rendering function. When the character 4 is displayed in a two-dimensional image (a plane image), the function related to the rendering may be omitted, of course.

The communication control section 294s performs data processing related to data communication, and implements exchange of data with an external device through the communication section 394s.

The communication section 394s connects to the network 9 to implement communication. For example, the communication section 394s is implemented by a transceiver, a modem, a terminal adaptor (TA), a jack for wired communication cable, a control circuit, and the like. The communication section 394s corresponds to the communication device 1153 in the example in FIG. 1.

The server storage section 500s stores programs and various types of data for implementing various functions for causing the server processing section 200s to entirely control the server system 1100. The server storage section 500s is used as a work area for the server processing section 200s, and temporarily stores results of calculations executed by the server processing section 200s in accordance with various programs. This function is implemented by an IC memory such as a RAM or a ROM, a magnetic disc such as a hard disc, an optical disc such as a CD-ROM or a DVD, an online storage, or the like, for example. The server storage section 500s corresponds to the storage media such as the IC memory 1152 and the hard disc included in the main body device and the purchase option DB 1140 in the example of FIG. 1.

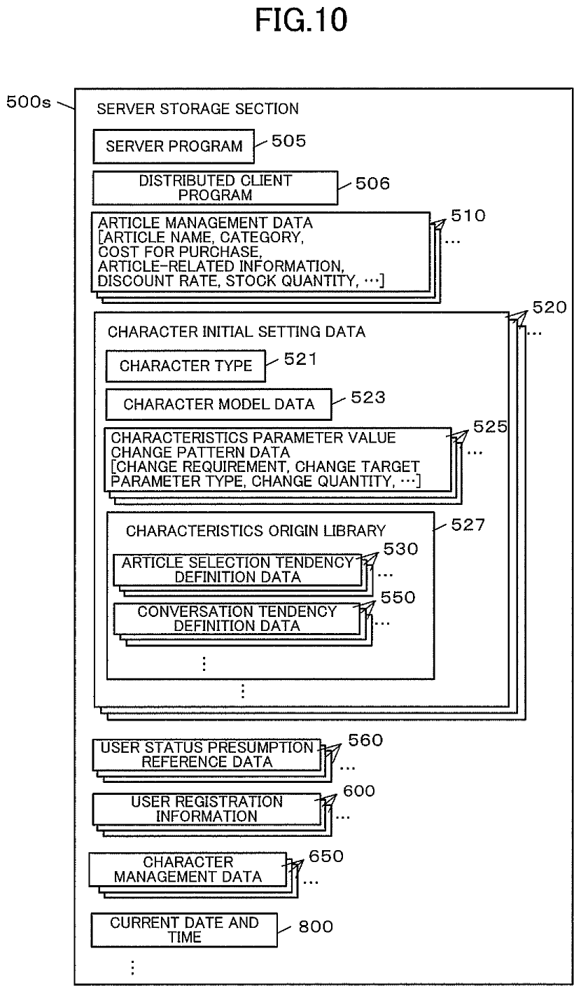

FIG. 10 is a diagram illustrating an example of the programs and data stored in the server storage section 500s.

The server storage section 500s stores a server program 505, a distributed client program 506, article management data 510, character initial setting data 520, user status presumption reference data 560, user registration information 600, character management data 650, and a current date and time 800. Note that other types of data can be stored as appropriate.

The article management data 510 is prepared for each article available for purchase through the automatic purchase system 1000. One article management data 510 includes, for example, an unique article name, an article category, cost for purchase, article-related information (e.g., color, size, a country of origin, or ingredients), a discount rate, and a stock quantity. Note that other types of data can be included as appropriate.

The character initial setting data 520 is prepared for each type of character 4, and includes various types of initial setting data related to the character and data related to the setting data.

One character initial setting data 520 includes, for example, a character type 521, character model data 523, characteristics parameter value change pattern data 525, and a characteristics origin library 527. Note that other types of data can be included as appropriate.

The characteristics parameter value change pattern data 525 is data defining a pattern of how to change the parameter value related to the characteristics of the character 4 (the character setting). The characteristics parameter value change pattern 525 is set to give a different pattern for each character type 521. Specifically, according to the present embodiment, each character 4 has the “intimacy degree”, which is a value indicating a degree of virtual affection or affinity that the character 4 has for the user 2 using the character, as a characteristics parameter value. The characteristics parameter value change pattern data 525 defines how to change the intimacy degree based on what kind of parameter.

Specifically, one characteristics parameter value change pattern data 525 includes information on a change requirement, a change target parameter type, and a change quantity. The characteristics parameter value change pattern data 525 is prepared with change pattern data as exemplified below.

That is, the characteristics parameter value change pattern data 525 includes change pattern data in which the change requirement is set to content corresponding to “a predetermined item for the character is given to the character” and the change target parameter value is set to “intimacy degree”. Accordingly, the character characteristics change control section 223 can control changing the intimacy degree of the character 4 that has received the item based on a result of a giving control of the item for the character.

Moreover, the characteristics parameter value change pattern data 525 includes change pattern data in which the change requirement is set to content corresponding to “purchase satisfying a given condition (described as a condition related to a purchase date and time, a type of purchased article, or a number of purchased articles, for example) is made” and the change target parameter value is set to “intimacy degree”. Accordingly, the character characteristics change control section 223 can control changing the character setting information related to the character characteristics of the character 4 based on a process result of the purchase process.

Moreover, the characteristics parameter value change pattern data 525 includes change pattern data in which the change requirement is set to “a gameplay result performed on the user terminal 1500 is updated” and the change target parameter value is set to “intimacy degree”. In this case, the change quantity is set to be determined depending on a record of the gameplay result. Accordingly, the character characteristics change control section 223 can control changing the character characteristics of the character 4 based on a game result of a given game performed on the user terminal 1500.

The user status presumption reference data 560 is prepared for each type of a state of the user 2 and a situation that the user is in at each time that are presumed based on the information (the collected information) related to the user 2 collected by the automatic purchase system 1000. The user status presumption reference data 560 defines a determination reference used to presume that the user 2 is in that state or situation.

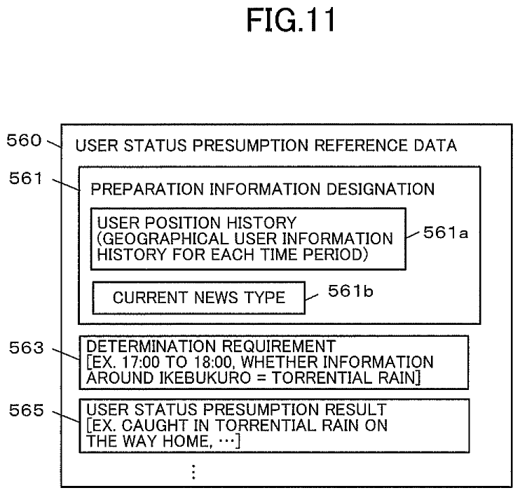

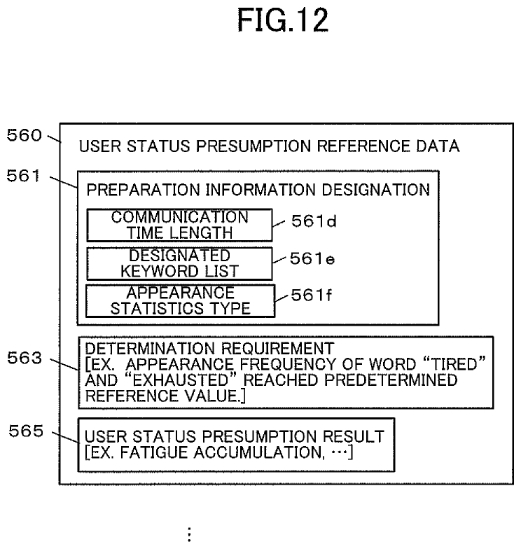

For example, FIG. 11 is a diagram illustrating an example of the user status presumption reference data 560 for presuming based on automatically acquired information by automatic circulation around websites on the Internet. FIG. 12 is a diagram illustrating an example of the user status presumption reference data 560 for presuming based on the communication history between the user 2 and the character 4.

One user status presumption reference data 560 includes a preparation information designation 561, a determination requirement 563, and a user status presumption result 565 in an associated manner.

The preparation information designation 561 designates information to be prepared as material for presuming based on this reference data.

Specifically, in the example of the preparation information designation 561 in FIG. 11, the preparation information designation 561 includes a user position history 561a and a current news type 561b. The user position history 561a is a list of geographical information on the position of the user 2 (e.g., an administrative district name, an area name, or a route name of a public transport) for each time period (e.g., morning, noon, evening, night, or commuting time) obtained from the behavior history information of the user 2. The user position history 561 may be read as tracking data of the user position. The current news type 561b designates a type of news (e.g., weather information, earthquake information, traffic information, event information, or bargain sale information). The automatic purchase system 1000 referring to the user status presumption reference data 560 in FIG. 11 obtains the user position history 561a from the behavior history information, performs an automatic circulation process around predetermined websites concerning the current news designated by the current news type 561b, and automatically acquires the designated current news related to the geographical information indicated by the user position history 561a.

Moreover, in the example of the preparation information designation 561 in FIG. 12, the preparation information designation 561 includes a communication time length 561d in a given designated period (e.g., today, or a past one week), a designated keyword list 561e, and an appearance statistics type 561f for each designated keyword. The automatic purchase system 1000 referring to the user status presumption reference data 560 in FIG. 12 obtains the communication time length 561d from the user terminal 1500, and then obtains a statistics value (e.g., a number of times of appearance, or an appearance ratio) indicated by the appearance statistics type 561f for each keyword indicated by the designated keyword list 561e.

The determination requirement 563 designates a requirement to admit a probability for deriving the user status presumption result 565 from the preparation information designation 561 prepared. The user status presumption result 565 indicates a presumed status of the user 2.

For example, the determination requirement 563 in FIG. 11 indicates a case that information (e.g., a torrential rain) of a type designated by the current news type 561b is automatically collected at a position in a time period (e.g., 17:00 to 18:00, around Ikebukuro) listed in the user position history 561a.

The user status presumption result 565 is set to “caught in a torrential rain on the way home”.

On reflection, the presumed user status condition in the article selection tendency definition data 530 (see FIG. 6) may be set to the user status presumption result 565 in the example in FIG. 11, and the tendency detail data 540 may be set to a tendency to select a countermeasure article against the torrential rain. As a result, it is possible to set a purchase behavior of the character 4 such that the character understands that the user 2 as its master was caught by the torrential rain and voluntarily purchases the article for the master.

In addition, for example, the determination requirement 563 in FIG. 12 indicates a case that the statistics value (e.g., a total number of times of appearance) designated by the appearance statistics type 561f of any one of keywords (e.g., a word or a phrase said when people are tired, such as tired or exhausted) in the designated keyword list 561e during the time designated by the communication time length 561d (e.g., for past three days) reaches the determination reference designated by the determination requirement 563. The user status presumption result 565 is set to “fatigue accumulation”.

On reflection, the presumed user status condition in the article selection tendency definition data 530 (see FIG. 6) may be set to the user status presumption result 565 in the example in FIG. 12, and the tendency detail data 540 may be set to a tendency to select a product or food useful for fatigue recovery, favorite food of the user 2 to cheer up the user 2, or the like. As a result, it is possible to set the purchase behavior of the character 4 such that the character 4 understands that the user 2 as its master is exhausted and voluntarily purchases the product or food for the master.

FIG. 13 is a diagram illustrating a data configuration example of the user registration information 600.

The user registration information 600 is prepared for each user 2 and includes various kind of registration information related to the user. Specifically, the user registration information 600 includes a unique user account 601, contract detail information 603, a character in use ID 605, personal information 610, a contract spending amount balance 620, and automatically collected information 622. Note that other types of data can be included as appropriate.

The contract detail information 603 includes, for example, a contract starting date and time 603a, a unit period 603b, a contract period 603c, a contract spending amount 603d, a deselection condition 603e, an automatic renewal setting 603f indicating whether automatic renewal after contract expiration is performed, and a balance handling setting 603g. Note that other types of information may be included depending on the contract details as appropriate.

The contract period 603c is described in an integer multiple of the unit period 603b. The user 2 can select a number of unit periods 603b to set as the contract period 603c when making a contract.

The contract spending amount 603d indicates the cost paid by the user 2 per unit period 603b of one unit (or per contract period 603c). The present embodiment employs a periodic purchase system that requires payment for the cost equivalent to the contract spending amount 603d before the unit period 603b begins. Thus, the contract spending amount 603d means a “prepaid cost”, however, a form of payment or meaning of the contract spending amount 603d is not limited to this. For example, the form of payment or meaning of the contract spending amount 603d may be an “individual automatic settlement” that does not include a fixed amount and requires automatic payment of the cost for each purchase, or a “maximum cost” that includes a maximum cost spendable in the unit period 603b. When making the contract, the user 2 is provided with a plurality of options, and sets the contract spending amount 603d by his/her setting operation.

The deselection condition 603e includes information for specifying items to be excluded from the article selection of the automatic purchase. For example, the deselection condition 603e includes an article name, a country of origin, an article category, remaining days to an expiry date, or ingredients. The information that can be set to the deselection condition 603e is supposed to be included in the information (the article-related information in the article management data 510) related to each article in the groups of articles (see FIG. 10).

The balance handling setting 603g is a setting of a way to handle the balance when the total amount of the purchase made through the purchase process during an elapsed unit period is smaller than the contract spending amount after the passage of the unit period 603b. The balance handling setting 603g is set by the user when the contract is made by performing a selection operation for selecting any one of options of “return”, “carry forward”, and “spend all”.

The personal information 610 includes profile information 611, electronic settlement information 613, and a shipping address 615. Note that other types of data can be included as appropriate.

The profile information 611 may include any information as appropriate. The profile information 611 may include, for example, an address, a name, age, a date of birth, sex, an occupation, a family structure, dates of birth of family members, interests and preferences, or the like. Information corresponding to a name of a hobby and details of the preferences that can be set to the interests and preferences is included in the information (the article-related information in the article management data 510) related to each article in the groups of articles, and thus whether the article suits the interests and preferences can be determined.

The electronic settlement information 613 is information to pay the contract spending amount 603d by electronic settlement. For example, the electronic settlement information 613 may be a credit card number, a prepaid point, or the like. The electronic settlement information 613 may be included in the contract detail information 603.

The contract spending amount balance 620 indicates a value of the balance obtained by subtracting the purchase cost for the article purchased in the current contract period 603c from the contract spending amount 603d. The selection process in the automatic selection of the article to purchase is performed such that a total purchase cost for the article to be purchased is equal to or lower than the value indicated by the contract spending amount balance 620.

The automatically collected information 622 includes information automatically collected by the server system 1100 and information derived from this information in relation to the user. Specifically, the automatically collected information 622 includes a duplicate behavior history information 623, automatic circulation collected information 624, a user status presumption result list 625, and communication history data 626.

The duplicate behavior history information 623 is a duplicate of the behavior history information 503 (see FIG. 8) recorded and managed on the user terminal 1500.

The automatic circulation collected information 624 is information acquired when the server system 1100 automatically circulates around the predetermined websites. The current news is included in this information.

The user status presumption result list 625 is a list of the user status presumption results 565 presumed to be the current status of the user 2 in accordance with the user status presumption reference data 560 (see FIGS. 11 and 12). The user status presumption result list 625 is used for the determination of the presumed user status condition 534d in the article selection tendency definition data 530 (see FIG. 6) and the presumed user status condition 554d in the conversation tendency definition data 550 (see FIG. 7).

The communication history data 626 is created whenever the communication between the user and the character 4 used by the user is performed, and records when and about what the communication is performed.

One communication history data 626 includes, for example, a character ID indicating a communication partner, a date and time of the communication, a character remark, and a user remark on a time-series basis. The date and time of the communication includes a date and time when the character 4 or the user 2 initiates the conversation and a date and time when the conversation pauses.

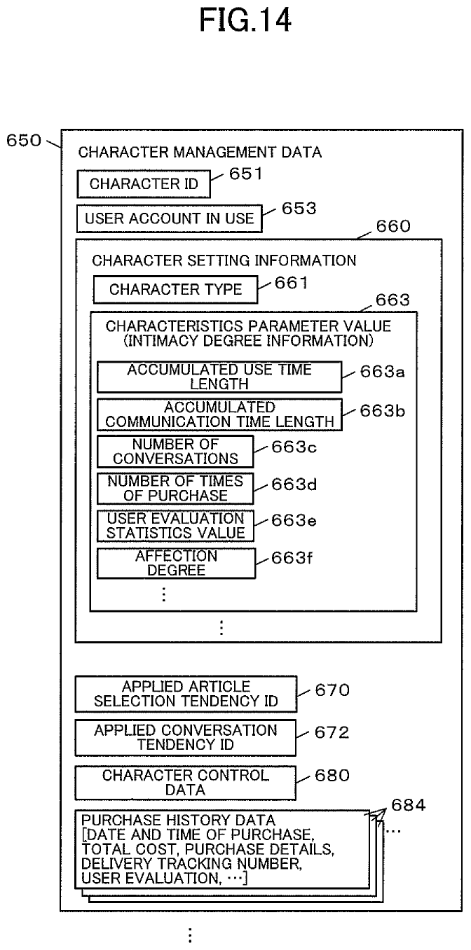

FIG. 14 is a diagram illustrating a data configuration example of the character management data 650.

The character management data 650 is prepared for each character 4 associated with the user 2, and includes various types of information related to the character. Specifically, one character management data 650 includes a unique character ID 651, a user account in use 653, character setting information 660, an applied article selection tendency ID 670, an applied conversation tendency ID 672, character control data 680, and purchase history data 684.

The character setting information 660 includes a latest setting parameter value of the character 4 managed by this management data. Specifically, the character setting information 660 includes a character type 661 and a characteristics parameter value 663. Note that other types of data can be included as appropriate.

The characteristics parameter value 663 includes a parameter value referred to for selecting the article selection tendency definition data 530 or the conversation tendency definition data 550 in accordance with the situation at each time from the characteristics origin library 527 (see FIG. 5), i.e., a parameter value determining the characteristics that actually appears. Thus, a change control of the characteristics parameter value 663 controls changing the character characteristics.

Specifically, the characteristics parameter value 663 includes an accumulated use time length 663a, an accumulated communication time length 663b, a number of conversations 663c, a number of times of purchase 663d, a user evaluation statistics value 663e, and an affection degree 663f. Note that conditions related to other parameters can be included as appropriate. For example, the characteristics parameter value 663 may include a condition concerning a total purchase amount until now, or a condition concerning a genre distribution of the purchased articles. On the contrary, one or more of the above-described examples may be omitted.

Each parameter included in the characteristics parameter value 663 can be considered as a parameter indicating a degree or a depth of a relationship between the user 2 and the character 4. Thus, the characteristics parameter value 663 can be considered as “intimacy degree information”.

The accumulated use time length 663a is an accumulated elapsed time since use of the character is started, and is automatically updated.

The accumulated communication time length 663b is accumulated time of the communication between the character and the user 2, and is automatically updated.

The number of conversations 663c is a total number of conversations between the character 4 and the user 2 when the character and the user 2 communicate by conversation, and is automatically updated.

The number of times of purchase 663d is an accumulated number of times of automatic purchase performed in relation to the character, and is automatically updated by the character characteristics change control section 223 whenever purchase is made.

The user evaluation statistics value 663e is a statistics value (e.g., an average value, a maximum value, a minimum value, or a median) of the user evaluations of the purchased articles by the automatic purchase in relation to the character, and is automatically updated by the character characteristics change control section 223 whenever the evaluation result is input. That is, the character characteristics change control section 223 controls changing the character characteristics of the character 4, which is involved in the purchase to which the evaluation is given, based on the evaluation result.

The affection degree 663f is a parameter value indicating a degree of affection or affinity that the character has for the user 2. For example, the affection degree 663f is indicated by an integer in a range from “0 (hate)” to “100 (like very much)” and an initial value at the beginning of the use is set to “50 (neutral)”.

The accumulated use time length 663a, the accumulated communication time length 663b, the number of conversations 663c, and the number of times of purchase 663d can be considered as parameters indicating experience values of the character as the assistant related to the automatic purchase. Especially, the accumulated communication time length 663b and the number of conversations 663c indicate higher value as the character and the user 2 are closer, and thus can be considered as parameters reflecting the intimacy degree between the character and the user.

The user evaluation statistics value 663e can be considered as a parameter indicating usefulness of the article selection by the character from a viewpoint of the user.

The affection degree 663f is automatically updated at a given timing by reference to the characteristics parameter value change pattern data 525 (see FIG. 10) associated with the character type of the character. The characteristics parameter value change pattern data 525 defines change details using variables such as the accumulated use time length 663a, the accumulated communication time length 663b, the number of conversations 663c, the number of times of purchase 663d, the user evaluation statistics value 663e, and a predetermined keyword included in words toward the character used in the communication.

Specifically, the characteristics parameter value change pattern data 525 is set to change the affection degree 663f higher when it can be determined that the accumulated communication time length 663b and the number of conversations 663c are steadily increasing relative to the accumulated use time length 663a. In addition, the characteristics parameter value change pattern data 525 is set to change the affection degree 663f higher as the evaluation in the user evaluation statistics value 663e is higher, and as an appearance ratio of a friendly keyword is higher. On the contrary, the characteristics parameter value change pattern data 525 is set to change the affection degree 663f lower as the evaluation in the user evaluation statistics value 663e is lower, and as an appearance ratio of an offensive or insulting keyword is higher.

The applied article selection tendency ID 670 indicates which article selection tendency definition data 530 in the characteristics origin library 527 is applied to the character now, and includes the tendency ID 531 (see FIG. 6).

The applied conversation tendency ID 672 indicates which conversation tendency definition data 550 in the characteristics origin library 527 is applied to the character now, and includes the tendency ID 551 (see FIG. 7).

The character control data 680 includes various types of control data for displaying the character and controlling various actions including communication.

The purchase history data 684 is created whenever the automatic purchase is performed, and records when the purchase is made, what is purchased, and how the user evaluation result is. One purchase history data 684 includes, for example, information on a date and time of purchase, a total cost, purchase details (a purchased number and a total cost for each article), a delivery tracking number, and a user evaluation result. Note that other types of data may be included as appropriate. The user evaluation result may be an evaluation of each type of an article in the purchase details, an evaluation of whole purchase at a time regardless of the number of types of the purchased articles, or both of them.

The purchase history data 684 may be an open type that can be referred to from the outside, or a closed type that cannot be referred to from the outside. The type of the data may be switched by the user 2. In addition, the purchase history data 684 itself may be deleted by the user 2 arbitrarily, or may be set to be automatically deleted at a given timing so as to perform a control for making it appear as part of automatic behavior of the character.

Next, operations of the automatic purchase system 1000 according to the present embodiment will be described.

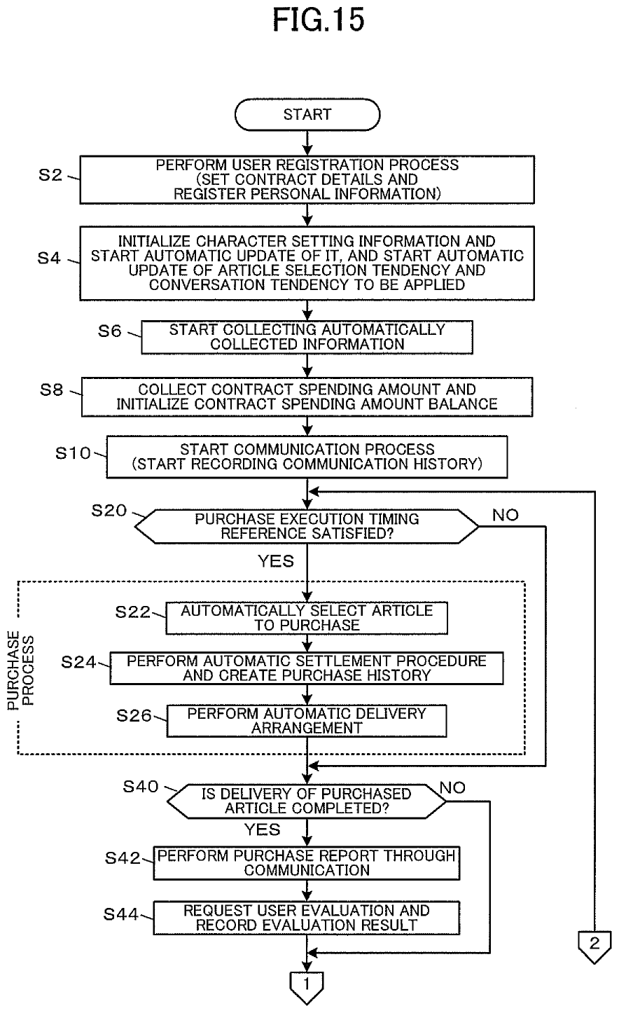

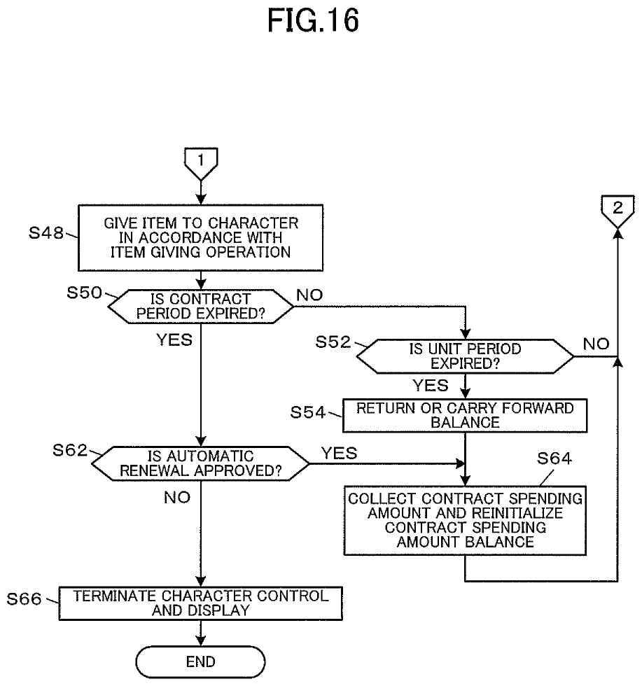

FIG. 15 and FIG. 16 are flowcharts illustrating flows of processes in relation to one user 2 in the server system 1100. Each flow of the process described herein is implemented through a communication connection between the user terminal 1500 executing the client program 502 and the server system 1100 executing the server program 505. When the user 2 operates the user terminal 1500, an operation input is sent to the server system 1100.

As illustrated in FIG. 15, the server system 1100 performs a user registration process (step S2).

Specifically, the server system 1100 displays options of contract details on the user terminal 1500, and receives setting operations. The user terminal 1500 sends information on the setting operations by the user to the server system 1100. The server system 1100 sets the contract detail information 603 of the user based on the setting operations by the user. Similarly, the server system 1100 receives and sets the user account 601 and the personal information 610 (see FIG. 13).

Next, the server system 1100 performs an initial setting of the character 4 used by the user 2, starts automatic update of the character setting information 660, and accordingly starts automatic update of the article selection tendency and the conversation tendency applied to the character (step 4).

Specifically, the server system 1100 displays selectable types of characters 4 on the user terminal 1500, and receives a selection of the type of the character by the user 2. The server system 1100 sets the received selection result as the character in use ID 605 (see FIG. 13) and the character type 661 of the character setting information 660 in the character management data 650 (see FIG. 14). Then, the server system 1100 sets the characteristics parameter value 663 to a predetermined initial value, and starts the automatic update of the characteristics parameter value 663.

In addition, the server system 1100 sets the applied article selection tendency ID 670 and the applied conversation tendency ID 672 to respective default values of the article selection tendency definition data 530 and the conversation tendency definition data 550 corresponding to the character in use. Thereafter, the server system 1100 selects one article selection tendency definition data, the applicable status 532 (see FIG. 6) of which is satisfied, from the article selection tendency definition data 530 of the characteristics origin library 527, and changes the applied article selection tendency ID 670 to the tendency ID 531 of the selected definition data at a given timing (e.g., at every passage of predetermined time period). Similarly, the sever system 1100 selects one conversation tendency definition data, the applicable status 552 (see FIG. 7) of which is satisfied, from the conversation tendency definition data 550 of the characteristics origin library 527, changes the applied conversation tendency ID 672 to the tendency ID 551 of the selected definition data, and repeats this control.

Next, the server system 1100 starts an automatic collection process for collecting the automatically collected information 622 (step S6).

Thereafter, the server system 1100 sends the user terminal 1500 a request for submission of the behavior history information 503 at a given timing. Upon receipt of the request, the user terminal 1500 returns the behavior history information 503. Then, the server system 1100 records this information as the duplicate behavior history information 622a.

Moreover, the server system 1100 collects the information designated in the preparation information designation 561 and stores it as the automatic circulation collected information 624 for each user status presumption reference data 560 (see FIG. 11 and FIG. 12) at a given timing. Then, the server system 1100 adds the user status presumption result 565 in the reference data, the determination requirement 563 of which is satisfied, to the user status presumption result list 625 (see FIG. 13) of the user registration information 600 of the user. On the contrary, the server system 1100 excludes the user status presumption result 565 in the reference data, the determination requirement 563 of which is not satisfied, from the user status presumption result list 625.

Next, the server system 1100 performs a collection process for collecting the contract spending amount 603d and initializes the contract spending amount balance 620 to the contract spending amount 603d collected (step S8). Then, the server system 1100 starts a communication process for performing the virtual communication between the character 4 and the user 2 (step S10). Then, the automatic purchase service by the automatic purchase system 1000 starts to be provided until the contract expires. The server system 1100 starts a continuous control of the action of the character 4. The character 4 is displayed in the screen of the user terminal 1500 and is controlled to behave as if the character 4 lived in it.

Specifically, the server system 1100 selects one daily conversation setting data, the speak condition of which is satisfied, from the daily conversation setting data 558 in the conversation tendency definition data 550 indicated by the applied conversation tendency ID672, and causes the character 4 to speak in accordance with the setting data. As a result, the user 2 can feel as if the character 4 talked to the user 2 to make conversation. In addition, in response to an input of a predetermined talking operation by the user 2 with the user terminal 1500, the character 4 behaves as if the character responded to the talking operation and made conversation. Whenever such communication is performed, the server system 1100 accumulates the communication history data 626 (see FIG. 14), and changes the parameter value related to the communication history in the character setting information 660.

The server system 1100 continuously monitors an arrival of a purchase execution timing after the communication process is started (step S20). Specifically, the server system 1100 monitors whether the purchase execution timing reference 541 in the article selection tendency definition data 530 indicated by the applied article selection tendency ID 670 is satisfied. Then, when the purchase execution timing reference 541 is satisfied (YES in the step S20), the server system 1100 performs a purchase process without notification to the user 2 (steps S22 to S26).

That is, the server system 1100 automatically selects an article to purchase within the contract spending amount balance 620 and the total cost per purchase condition 542 in the article selection tendency definition data 530 indicated by the applied article selection tendency ID 670 (step S22). In the selection, the server system 1100 selects an article to purchase such that the purchase article selection tendency setting data 544 in the article selection tendency definition data 530 is satisfied and articles satisfying the deselection condition 603e are excluded.

Next, the server system 1100 automatically takes a settlement procedure by subtracting the cost for the purchase from the contract spending amount balance 620, and creates a new purchase history data 684 (step S24). Then, the server system 1100 automatically performs delivery arrangement for the new purchased article (step S26). The delivery arrangement is performed using an automatic reception system provided by an existing home delivery company. At this time, the server system 1100 acquires a delivery tracking number individually provided, and registers it to the purchase history data 684 newly created. The user evaluation in the history data takes “not evaluated” as an initial value.

The server system 1100 continuously monitors the delivery status of the purchased article with the user evaluation in the purchase history data 684 remaining “not evaluated” (step S40). Specifically, the server system 1100 automatically circulates around the website managed by the home delivery company to acquire latest delivery status information using the delivery tracking number acquired in the delivery arrangement.

When the delivery status indicates completion of the delivery, the server system 1100 determines that the user 2 has received the purchased article. Then, the server system 1100 causes the character 4 to perform the purchase report (step S42) and to request the user evaluation of the purchased article related to the purchase report, and records the user evaluation (step S44). Specifically, the server system 1100 searches purchase report setting data, the report execution condition of which is satisfied, from the purchase report setting data 559 in the conversation tendency definition data 550 indicated by the applied conversation tendency ID 672, and causes the character to report on the purchased article through communication with the character 4 in accordance with the searched setting data. In addition, the server system 1100 causes the character 4 to speak the remark for requesting the evaluation in accordance with the setting of the setting data to invite the user to input the user evaluation. The server system 1100 records the input user evaluation in the purchase history data 684 (see FIG. 14) related to the purchased article reported.

Referring to FIG. 16, the server system 1100 gives the character 4 an item for the character in accordance with an input of an item giving operation (step S48).

The server system 1100 monitors whether the contract period 603c has expired after the step S10. When the contract period 603c has not expired (No in the step S50), the server system 1100 further determines whether the unit period 603b has expired. When the unit period 603b has expired (YES in the step S52), the server system 1100 performs a control for returning the contract spending amount balance 620 at this point to the user 2 by valuable information, or for carrying it forward to the next unit period 603b (step S54) in accordance with the setting of the balance handling setting 603g. Then, the server system 1100 collects the contract spending amount 603d, initializes the contract spending amount balance 620 again (step S64), and continues providing the service.

When the contract period 603c has expired (YES in the step S50) and the automatic renewal setting 603f is set to “automatic renewal approved” (YES in the step S62), the server system 1100 collects the contract spending amount 603d, initializes the contract spending amount balance 620 again (step S64), and continues providing the service.

However, when the automatic renewal setting 603f is not set to “automatic renewal approved” (NO in the step S62), the server system 1100 terminates the control and display of the character 4 (step S66), and terminates the series of processes.

As described above, according to the present embodiment, the automatic purchase system 1000 can control the character 4 as an assistant related to the automatic purchase to provide the user 2 with a virtual communication experience by text-based conversation, and automatically collect various types of information related to the user including the communication history. The automatic purchase system 1000 can also automatically select an article, make settlement, and arrange the delivery based on the communication history without being noticed by the user 2. From the viewpoint of the user 2, an article is purchased and delivered to the user before the user knows it. Thus, the user can feel joy and pleasure as if to receive a present that someone else voluntarily purchased for the user.

### Second Embodiment

Next, a second embodiment of the present disclosure will be described. When the present embodiment and the first embodiment are compared, differences lie in that the automatic purchase management section 210 is implemented by the server system 1100 in the first embodiment while it is implemented by the user terminal 1500 in the present embodiment. The following mainly describes differences from the first embodiment. Components that are the same as those in the first embodiment are denoted with the same referential numerals, and duplicate description will be omitted.

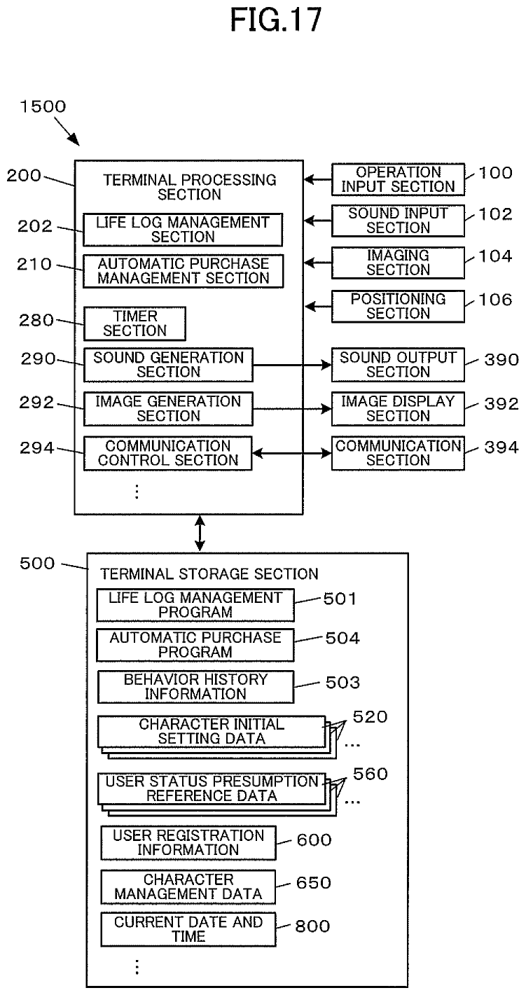

The server system 1100 according to the present embodiment is in charge of managing article management data 510 and providing information to the user terminal 1500. The server system 1100 dose not have a function of the automatic purchase management section 210, and functions in a stand-alone manner. That is, as illustrated in FIG. 17, the user terminal 1500 includes the automatic purchase management section 210 in place of the client terminal control section 204 (see FIG. 8).

As a result, the terminal storage section 500 stores an automatic purchase program 504 for causing the terminal processing section 200 to implement the functions as the automatic purchase management section 210, the character initial setting data 520, the user status presumption reference data 560, the user registration information 600 related to the user using the user terminal 1500, and the character management data 650.

As for the article management data 510, the user terminal 1500 may access the server system 1100 to refer to the article management data whenever performing the automatic selection of an article to purchase, or may download it from the server system 1100 at given timing and store a duplicate in the terminal storage section 500 to refer to.

The flow of the process related to the automatic purchase by the user terminal 1500 according to the present embodiment is similar to the flow illustrated in the flowchart in FIG. 15. That is, an executing subject of various processes and controls in the flowcharts in FIG. 15 and FIG. 16 is required to be changed from the server system 1100 to the user terminal 1500. Thus, the present embodiment can provide the same advantageous effects as those in the first embodiment.

### MODIFICATION EXAMPLES

The embodiments to which the present disclosure is applied have been described so far. However, the modes to which the present disclosure is applicable are not limited to the foregoing embodiments, and the components can be added, omitted, or changed as appropriate.

### Modification Example 1

For example, in the first embodiment, the automatic purchase system 1000 is implemented in a client-server computer system. Alternatively, the automatic purchase system 1000 may be implemented by a computer system in which the server system 1100 is omitted and a plurality of user terminals 1500 are connected in a peer-to-peer fashion. In such a case, any of the user terminals 1500 performs the functions of the server system 1100 in the first embodiment. Alternatively, a plurality of user terminals 1500 may share out the functions of the automatic purchase management section 210.

Similarly, sharing out the functions of the automatic purchase management section 210 may be implemented by taking the first embodiment as a base, and implementing and sharing part of the functions of the automatic purchase management section 210 (e.g., the character management section 220, or the communication history management section 232) by the plurality of user terminals 1500.

### Modification Example 2

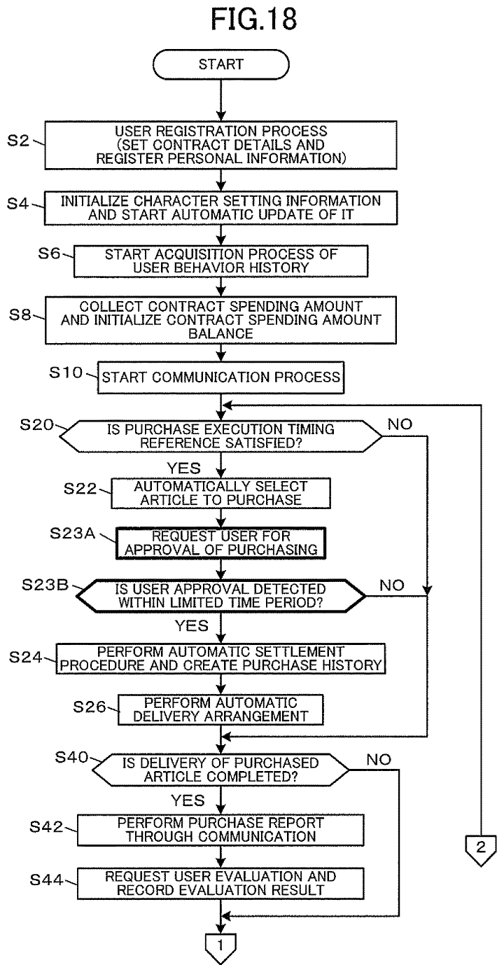

Furthermore, according to the above-described embodiments, no approval of the user 2 is required for the purchase because a surprise element in the automatic purchase is regarded as important, however, approval of the user 2 may be required. Details will be described based on the first embodiment. As illustrated in FIG. 18, the server system 1100 controls the character 4 to ask the user 2 for approval of purchasing an article selected by the automatic article selection after the automatic selection of the article to purchase (step S23A). Then, the server system 1100 stays in a waiting state for the purchase of the article for a predetermined limited time period after the automatic article selection. When the server system 1100 detects user approval (e.g., an operation on a YES/NO input icon, or input of a word meaning approval) (YES in the step S23B) within the limited time period, the server system 1100 processes an automatic settlement procedure and delivery arrangement. When the server system 1100 does not obtain the user approval within the limited time period (NO in the step S23B), the server system 1100 skips processing the automatic settlement procedure and delivery arrangement.

With this configuration, when a remark of the character 4 requesting the approval in a proposal manner is adopted, such as “I think (a name of an article to purchase) would be good for you. What do you think?”, the automatic purchase system 1000 functions as a proposal system of a purchased article.

In addition, as described above, the purchase option DB 1140 is not limited to a data base owned by an article provider providing articles, but may be a mail order website, a reservation website for accommodations, or the like. In such a case, the automatic purchase system 1000 practically functions as a concierge-type automatic purchase system 1000 that automatically circulates around mail order websites or reservation websites for accommodations or the like via the Internet or the like to select and propose an article to purchase.

### Modification Example 3

Furthermore, a number of characters 4 for each user may be set as appropriate. One user 2 may user a plurality of characters 4. In such a case, the plurality of characters 4 may actually be one character controlled by one character management data 650 in an internal process though it appears that the plurality of characters exist. Or, each of the plurality of characters 4 may be assigned with the character management data 650, of course.

In addition, the latter case (a configuration assigning the character management data 650 to each of the plurality of characters 4) may include a configuration that the contract spending amount 603d is assigned to each of the plurality of characters 4 by the user 2.

That is, the purchase control section 234 may consider a spendable amount assigned for each character 4 from the contract spending amount in accordance with an setting operation by the user as a contract spending amount related to the character in the automatic purchase so as to perform the purchase process for each character.

### Modification Example 4

The characteristics origin library 527 itself or the data included in the library is not necessarily fixed, and may be changed as appropriate.

For example, the characteristics origin library 527 may be changed by an operator of the automatic purchase system 1000, or may be separately purchased by the user 2 on a mail order website managed by the operator of the automatic purchase system 1000 (or may be purchased using an online shopping function provided in the service of the automatic purchase system 1000).

### Modification Example 5

Furthermore, a setting value of each item in the tendency detail data 540 (see FIG. 6) may be determined on each occasion based on the character setting information 660 of the character 4.

Specifically, for example, the characteristics parameter value 663 may include a “lavish spending degree setting value” as a personality parameter value related to a way of spending money, and the total cost per purchase condition 542 may be set to a function or table data for calculating a total cost with the “lavish spending degree setting value” as a variable.

In addition, for example, the characteristics parameter value 663 may include a “preference setting value” as a personality parameter value related to a preference, and the rare article selection priority degree 544d may be set to a function or table data for calculating a priority degree with the “preference setting value” as a variable.

Any other items of the tendency detail data 540 defined by the functions or table data or any other parameters included in the character setting information 660 used as the variables of the functions or table data may be combined and set as appropriate.

Furthermore, an initial value of the parameter included in the character setting information 660 used as the variable of the function or the table data may be set by the user 2 himself/herself. For example, with the first embodiment as a base, the server system 1100 may provide the user 2 with distributable “100” points as one of the processes related to the initialization of the character setting information 660. Then, in accordance with a distribution operation by the user 2, the server system 1100 may perform a process to set distributed points as initial values of the parameters.

### Modification Example 6

Furthermore, the automatic purchase system 1000 according to the above-described embodiments may also serve as a game providing system providing an online game using the user terminal 1500. Specifically, in response to an input of a gameplay start operation on the user terminal 1500, the server system 1100 may start a function as a game server. In such a case, the character 4 serves as a player character that the user 2 operates and grows, or a non player character (NPC) accompanying the player character.

### Modification Example 7

Furthermore, according to the above-described embodiments, each user 2 personally selects the character 4 to use. That is, the character 4 of each user 2 is unique to the user, however, it is not limited to this. For example, in a process of selecting the character 4, options may include a copy of a character 4 used by other users (e.g., a character 4 of a famous person, or a character 4 selected at random).

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

What is claimed is:

1. A computer system comprising:
at least one processor or circuit programmed to:
manage user registration information of a user;
manage a given character in association with character characteristics of the character, the character appearing in virtual communication performed by the user with the character as a partner on a user terminal; and
automatically select an article to purchase from a group of purchase option data including accumulated data of purchase options by using at least a purchase article selection tendency based on the character characteristics, the purchase options including substantial articles in a real world and/or items in a virtual world.

2. The computer system as defined in claim 1, wherein
the at least one processor or circuit is further programmed to
control the character to control execution of communication.

3. The computer system as defined in claim 2, wherein managing the given character includes performing a control for changing the character characteristics.

4. The computer system as defined in claim 3, wherein
performing the control for changing the character characteristics includes performing a control for changing the character characteristics based on a communication history.

5. The computer system as defined in claim 4,
wherein the character characteristics include an intimacy degree of the character toward the user, and
wherein performing the control for changing the character characteristics includes performing a control for changing the intimacy degree based on the communication history.

6. The computer system as defined in claim 5, wherein
the purchase article selection tendency includes a selection tendency of an article to purchase based on the intimacy degree.

7. The computer system as defined in claim 5,
wherein the at least one processor or circuit is further programmed to perform a control for giving the character a given item based on an operation input by the user, and
wherein performing the control for changing the character characteristics includes performing a control for changing the intimacy degree when the control for giving the item is performed.

8. The computer system as defined in claim 3, wherein
performing the control for changing the character characteristics includes performing a control for changing the character characteristics based on a game result of a given game executed on the user terminal.

9. The computer system as defined in claim 3,
wherein the user registration information includes a contract spending amount of the user, and
wherein selecting the article to purchase includes performing a purchase process by selecting a purchase option, a cost of which is within the contract spending amount, as the article to purchase.

10. The computer system as defined in claim 9, wherein
performing the control for changing the character characteristics includes performing a control for changing the character characteristics based on a process result of the purchase process.

11. The computer system as defined in claim 9, wherein
controlling the execution of the communication includes controlling the communication of the character to cause the character to ask an evaluation of the article purchased through the purchase process.

12. The computer system as defined in claim 11, wherein
performing the control for changing the character characteristics includes performing a control for changing the character characteristics based on the evaluation.

13. The computer system as defined in claim 9, wherein
controlling the execution of the communication includes controlling the communication of the character to cause the character to report to the user as if the character itself had made a purchase through the purchase process.

14. The computer system as defined in claim 12, wherein
controlling the execution of the communication includes controlling the communication of the character to cause the character to report to the user as if the character itself had made a purchase through the purchase process.

15. The computer system as defined in claim 9,
wherein the user registration information includes a contract period set based on a setting operation by the user with a unit period as one unit,
wherein the contract spending amount is an amount per unit period, and
wherein selecting the article to purchase includes performing the purchase process for each passage of the unit period.

16. The computer system as defined in claim 15, wherein
selecting the article to purchase includes performing the purchase process by selecting an article to purchase for the contract spending amount in the unit period corresponding to a current date and time.

17. The computer system as defined in claim 15, wherein
the at least one processor or circuit is further programmed to
perform a control for giving the user valuable information corresponding to an amount of a balance when a total amount of purchase made through the purchase process during an elapsed unit period is smaller than the contract spending amount after the passage of the unit period.

18. The computer system as defined in claim 15, wherein
selecting the article to purchase includes performing the purchase process by adding an amount of a balance to the contract spending amount in a subsequent unit period when a total amount of purchase made through the purchase process during an elapsed unit period is smaller than the contract spending amount after the passage of the unit period.

19. The computer system as defined in claim 1,
wherein the user registration information includes profile information of the user, and
wherein the purchase article selection tendency includes a selection tendency of an article to purchase based on the profile information.

20. An automatic purchase system comprising:
the user terminal of the user; and
the server system as defined in claim 1.

21. An automatic purchase method executed by a computer system, the method comprising;
managing user registration information of a user;
managing a given character in association with character characteristics of the character, the character appearing in virtual communication performed by the user with the character as a partner on a user terminal, and
automatically selecting an article to purchase from a group of purchase option data including accumulated data of purchase options by using at least a purchase article selection tendency based on the character characteristics, the purchase options including substantial articles in a real world and/or items in a virtual world.
